(19) United States
(12) Patent Application Publication
(10) Pub. No.: US 2018/0167697 A1
(43) Pub. Date: Jun. 14, 2018

(54) DATA COLLECTION DEVICE, VIDEO GENERATION DEVICE, VIDEO DELIVERY SYSTEM, PROGRAM, AND RECORDING MEDIUM

(71) Applicant: SEIKO EPSON CORPORATION, Tokyo (JP)

(72) Inventor: Eiji MIYASAKA, Okaya-shi (JP)

(73) Assignee: SEIKO EPSON CORPORATION, Tokyo (JP)

(21) Appl. No.: 15/828,905

(22) Filed: Dec. 1, 2017

(30) Foreign Application Priority Data
Dec. 9, 2016 (JP) 2016-239666

(51) Int. Cl. H04N 21/81; H04N 21/854; H04N 21/422; H04N 21/235

(52) U.S. Cl. CPC H04N 21/8133; H04N 21/854; A63B 24/0062; H04N 21/42201; H04N 21/235; H04N 21/8153

(57) ABSTRACT

A data collection device receives exercise information transmitted from an electronic device that is worn on a player, determines a plurality of states including a first exercise state in which the player is executing a first exercise event and a second exercise state in which the player is executing a second exercise event based on a satellite signal transmitted from a positional information satellite, and generates the exercise information regarding the player including the determined states, and generates first information including information related to objects which are based on the determined states based on the received exercise information.

This application claims the benefit of Japanese Application No. JP 2016-239666 filed Dec. 9, 2016. The disclosure of the prior application is hereby incorporated by reference herein in its entirety.

### BACKGROUND

### 1. Technical Field

The present invention relates to a data collection device, a video generation device, a video delivery system, a program, and a recording medium.

### 2. Related Art

JP-A-2004-192632 discloses a game watching system that delivers a biological signal of an athlete or an animal to a viewer in real time via an information delivery medium in sports or a game.

However, for example, when the game watching system disclosed in JP-A-2004-192632 is applied to a game in which athletes execute a plurality of exercise events such as a triathlon, viewers (audience) can know biological information regarding the athletes, but may not know which exercise events the athletes are executing. That is, in the game watching system disclosed in JP-A-2004-192632, there is a problem that information regarding exercise events which athletes are executing may not be supplied in television broadcast or Internet broadcast of a game in which exercise events executed by the athletes continuously switch.

### SUMMARY

An advantage of some aspects of the invention is to provide a data collection device, a program, and a storage medium capable of generating information available to generate a video including information regarding exercise events which players are executing in a game in which the exercise events continuously switch. Another advantage of some aspects of the invention is to provide a video generation device, a video delivery system, a program, and a storage medium capable of generating and delivering a video including information regarding exercise events which players are executing in a game in which the exercise events continuously switch.

The invention can be implemented as the following forms or application examples.

### APPLICATION EXAMPLE 1

A data collection device according to this application example receives exercise information regarding the player transmitted from an electronic device that is worn on a player, determines a plurality of states including a first exercise state in which the player is executing a first exercise event and a second exercise state in which the player is executing a second exercise event based on a satellite signal transmitted from a positional information satellite, and generates the exercise information including the determined state, and generates first information including information related to objects which are based on the determined state based on the received exercise information.

The data collection device according to this application example generates the first information including the objects which are based on the first exercise state in the first exercise state in which the player is executing the first exercise event and generates the first information including the information related to the objects which are based on the second exercise state in the second exercise state in which the player is executing the second exercise event based on the exercise information regarding the player transmitted and received from the electronic device. Accordingly, the data collection device according to the application example can generate information available to generate the video including the information regarding the exercise event which the player is executing in a game in which the exercise events continuously switch.

In the data collection device according to the application example, the electronic device worn on the player can determine the first exercise state in which the player is executing the first exercise event and the second exercise state in which the player is executing the second exercise event. Therefore, manual work of the player is not necessary when the exercise event executed by the player switches from the first exercise event to the second exercise event. Accordingly, the player can focus the game.

### APPLICATION EXAMPLE 2

In the data collection device according to the application example, the plurality of exercise states may include a third exercise state in which the player is executing a third exercise event.

The data collection device according to this application example generates the first information including the objects which are based on the third exercise state in the third exercise state in which the player is executing the third exercise event based on the exercise information regarding the player transmitted and received from the electronic device. Accordingly, the data collection device according to the application example can generate the information available to generate the video including the information related to the exercise event which the player is executing.

### APPLICATION EXAMPLE 3

In the data collection device according to the application example, the plurality of exercise states may include a first transition state in which the first exercise state is transitioning to the second exercise state and a second transition state in which the second exercise state is transitioning to the third exercise state.

The data collection device according to this application example generates the first information including the objects which are based on the first transition state in the first transition state in which the first exercise state of the player is transitioning to the second exercise state and generates the first information including the objects which are based on the second transition state in the second transition state in which the second exercise state of the player is transitioning to the third exercise state based on the exercise information regarding the player transmitted and received from the electronic device. Accordingly, the data collection device according to the application example can generate the information available to generate the video including the information related to the exercise event which the player is executing or transitioning.

### APPLICATION EXAMPLE 4

In the data collection device according to the application example, the first exercise event may be a swim, the second exercise event may be a bicycle, and the third exercise event may be a running.

The data collection device according to this application example can generate the information available to generate the video including the information regarding whether the player is executing one of the swim, the bicycle, and the run in the triathlon, whether the player is transitioning from swim to the bicycle, or whether the player is transitioning from the bicycle to the running.

### APPLICATION EXAMPLE 5

In the data collection device according to the application example, the exercise information may include an elapsed time in the determined state. The first information may include information related to the elapsed time.

The data collection device according to this application example can generate the information related to the exercise event which the player is executing or the information available to generate the video including the information regarding the elapsed time in the exercise event which the player is executing.

### APPLICATION EXAMPLE 6

In the data collection device according to the application example, the exercise information may include information related to an exercise situation of the player. Second information including a graph that chronologically shows a change in the exercise situation of the player over time may be generated based on the exercise information.

The exercise situation may be biological information (a heart rate, a pulse rate, or the like) or result information (a pace, a speed, a pitch, a stride, an elapsed time, or the like) regarding the player.

The data collection device according to this application example generates the second information including the information related to the graph that chronologically shows the change in the exercise situation of the player based on the exercise information regarding the player transmitted and received from the electronic device. Accordingly, the data collection device according to the application example can generate the information available to generate the video including the information regarding the trend of the exercise situation of the player.

### APPLICATION EXAMPLE 7

The data collection device according to the application example may receive a plurality of the pieces of exercise information from a plurality of the electronic devices worn on a plurality of the players. The first information may include information related to at least one of the plurality of objects associated with the plurality of players.

The data collection device according to this application example can generate the information available to generate the video including the information related to the exercise event which each of the plurality of players is executing.

### APPLICATION EXAMPLE 8

The data collection device according to the application example may receive selection information which is based on a signal transmitted from a communicable display device and may select information related to at least one object is selected from the plurality of objects based on the received selection information.

The data collection device according to this application example can generate the information available to generate the video including the information related to the exercise event which the player selected by a user (viewer) of the display device is executing.

### APPLICATION EXAMPLE 9

A video generation device according to this application example receives, from a data collection device, first information including information related to the objects which are based on a determined state from a plurality of states including a first exercise state in which a player is executing a first exercise event and a second exercise state in which the player is executing a second exercise event, generates a first video including the objects based on the received first information, and delivers the generated first video to a display device.

The video generation device according to this application example generates the first video including the objects which are based on the first exercise state in which the player is executing the first exercise event or the objects which are based on the second exercise state in which the player executing the second exercise event based on the first information transmitted and received from the data collection device, and delivers the first video to the display device. Accordingly, the video generation device according to the application example can generate the video including the information related to the exercise event which the player is executing in a game in which the exercise events continuously switch and can deliver the video to the display device.

### APPLICATION EXAMPLE 10

In the video generation device according to the application example, the plurality of exercise states may include a third exercise state in which the player is executing a third exercise event.

On the first information transmitted and received from the data collection device, the video generation device according to the application example generates the first video including the objects which are based on the third exercise state in which the player is executing the third exercise event and delivers the first video to the display device. Accordingly, the video generation device according to this application example can generate the video including the information related to the exercise event which the player is executing and can deliver the video to the display device.

### APPLICATION EXAMPLE 11

In the video generation device according to the application example, the plurality of states may include a first transition state in which the first exercise state is transitioning to the second exercise state and a second transition state in which the second exercise state is transitioning to the third exercise state.

On the first information transmitted and received from the data collection device, the video generation device according to the application example generates the first video including the objects which are based on the first transition state in which the player is transitioning the first exercise state to the second exercise state and the objects which are based on the second transition state in which the player is transitioning the second exercise state to the third exercise state and delivers the first video to the display device. Accordingly, the video generation device according to this application example can generate the video including the information related to the exercise event which the player is executing and can deliver the video to the display device.

### APPLICATION EXAMPLE 12

In the video generation device according to the application example, the first exercise event may be a swim, the second exercise event may be a bicycle, and the third exercise event may be a running.

The video generation device according to this application example can generate the video including the information regarding whether the player is executing one of the swim, the bicycle, and the running in the triathlon, whether the player is transitioning from swim to the bicycle, or whether the player is transitioning from the bicycle to the run and can deliver the video to the display device.

### APPLICATION EXAMPLE 13

In the video generation device according to the application example, the first information may include information related to an elapsed time in the determined state. The first video including the elapsed time may be generated based on the received first information.

The video generation device according to this application example can generate the video including information related to the exercise event which the player is executing or the information regarding the elapsed time in the exercise event which the player is executing and can deliver the video to the display device.

### APPLICATION EXAMPLE 14

In the video generation device according to the application example, second information including information related to a graph that chronologically shows a change in an exercise situation of the player may be received from the data collection device. A second video including the graph may be generated based on the received second information. The generated second video may be delivered to the display device.

The video generation device according to this application example generates the second video including the graph that chronologically shows the change in the exercise situation of the player based on the second information transmitted and received from the data collection device and delivers the second video the display device. Accordingly, the video generation device according to the application example can generate the video including the information regarding the trend of the exercise situation of the player and can deliver the video to the display device.

### APPLICATION EXAMPLE 15

In the video generation device according to the application example, the first information may include information related to at least one of the plurality of objects associated with a plurality of the players. The first video including the plurality of objects may be generated based on the received first information.

The video generation device according to this application example can generate the video including the information related to the exercise event which each of the plurality of players is executing and can deliver the video to the display device.

### APPLICATION EXAMPLE 16

In the video generation device according to the application example, the data collection device may receive selection information which is based on a signal transmitted from the display device and may select information related to at least one object from the plurality of objects based on the received selection information.

The video generation device according to this application example can generate the video including the information related to the exercise event which the player selected by a user (viewer) of the display device is executing and can deliver the video to the display device.

### APPLICATION EXAMPLE 17

A video delivery system according to this application example includes an electronic device worn on a player, a data collection device, and a video generation device. The electronic device determines a plurality of exercise states including a first exercise state in which the player is executing a first exercise event and a second exercise state in which the player is executing a second exercise event based on a satellite signal received from a positional information satellite, generates exercise information regarding the player including the determined exercise states, and transmits the generated exercise information to the data collection device. The data collection device receives the exercise information from the electronic device, generates the first information including information related to an object which is based on the determined state based on the received exercise information, and transmits the generated first information to the video generation device. The video generation device receives the first information from the data collection device, generates a first video including the object based on the received first information, and delivers the generated first video to the display device.

In the video delivery system according to this application example, based on the exercise information regarding the player transmitted and received from the electronic device, the data collection device generates the first information including the objects which are based on the first exercise state in the first exercise state in which the player is executing the first exercise event, generates the first information including the information related to the objects which are based on the second exercise state in the second exercise state in which the player is executing the second exercise event, and transmits the first information to the video generation device. The video generation device generates the first video including the objects which are based on the first exercise state in which the player is executing the first exercise event and the objects which are based on the second exercise state in which the player is executing the second exercise event, and delivers the first video to the display device based on the first information transmitted and received from the data collection device. Accordingly, in the video delivery system according to the application example, the video including the information related to the exercise event which the player is executing in a game in which the exercise events continuously switch and the video can be generated and delivered to the display device.

In the video delivery system according to this application example, the electronic device worn on the player can determine the first exercise state in which the player is executing the first exercise event and the second exercise state in which the player is executing the second exercise event. Therefore, manual work of the player is not necessary when the exercise event executed by the player switches from the first exercise event to the second exercise event. Accordingly, the player can focus on the game.

### APPLICATION EXAMPLE 18

A program according to this application example causes a computer to perform: receiving exercise information regarding the player transmitted from an electronic device that is worn on a player, determines a plurality of states including a first exercise state in which the player is executing a first exercise event and a second exercise state in which the player is executing a second exercise event based on a satellite signal transmitted from a positional information satellite, and generates the exercise information including the determined state; and generating first information including information related to objects which are based on the determined state based on the received exercise information.

The computer executing the program according to this application example generates the first information including the objects which are based on the first exercise state in the first exercise state in which the player is executing the first exercise event based on the exercise information regarding the player transmitted and received from an electronic device and generates the first information including the information related to the objects which are based on the second exercise state in the second exercise state which the player is executing the second exercise event. Accordingly, according to the program according to the application example, it is possible to generate the information available to generate the video including the information related to the exercise event which the player is executing in a game in which the exercise events continuously switch.

According to the program according to this application example, the electronic device worn on the player can determine the first exercise state in which the player is executing the first exercise event and the second exercise state in which the player is executing the second exercise event. Therefore, manual work of the player is not necessary when the exercise event executed by the player switches from the first exercise event to the second exercise event. Accordingly, the player can focus on the game.

### APPLICATION EXAMPLE 19

A program according to this application example causes a computer to perform receiving, from a data collection device, first information including information related to objects which are based on a determined state from a plurality of states including a first exercise state in which a player is executing a first exercise event and a second exercise state in which the player is executing a second exercise event, generating a first video including the objects which are based on the received first information, and delivering the generated first video to a display device.

The computer causing the program according to this application example generates the first video including the objects which are based on the first exercise state in which the player is executing the first exercise event or the objects which are based on the second exercise state in which the player executing the second exercise event based on the first information transmitted and received from the data collection device and delivers the first video to the display device. Accordingly, according to the program according to the application example, it is possible to generate the video including the information related to the exercise event which the player is executing in a game in which the exercise events continuously switch and deliver the video to the display device.

### APPLICATION EXAMPLE 20

A recording medium according to this application example is a computer-readable recording medium that stores a program causing a computer to perform receiving exercise information regarding the player transmitted from an electronic device that is worn on a player, determines a plurality of states including a first exercise state in which the player is executing a first exercise event and a second exercise state in which the player is executing a second exercise event based on a satellite signal transmitted from a positional information satellite, and generates the exercise information including the determined state; and generating first information including information related to objects which are based on the determined state based on the received exercise information.

The computer executing the program recorded on this recording medium according to the application example generates the first information including the objects which are based on the first exercise state in the first exercise state in which the player is executing the first exercise event based on the exercise information regarding the player transmitted and received from an electronic device and generates the first information including the information related to the objects which are based on the second exercise state in the second exercise state which the player is executing the second exercise event. Accordingly, according to the recording medium according to the application example, it is possible to generate the information available to generate the video including the information related to the exercise event which the player is executing in a game in which the exercise events continuously switch.

According to the recording medium according to this application example, the electronic device worn on the player can determine the first exercise state in which the player is executing the first exercise event and the second exercise state in which the player is executing the second exercise event. Therefore, manual work of the player is not necessary when the exercise event executed by the player switches from the first exercise event to the second exercise event. Accordingly, the player can focus on the game.

### APPLICATION EXAMPLE 21

A recording medium according to this application example is a computer-readable recording medium that stores a program causing the computer to perform receiving, from a data collection device, first information including information related to objects which are based on a determined state from a plurality of states including a first exercise state in which a player is executing a first exercise event and a second exercise state in which the player is executing a second exercise event, generating a first video including the objects which are based on the received first information, and delivering the generated first video to a display device.

The computer executing the program recorded on this recording medium according to the application example generates the first video including the objects which are based on the first exercise state in which the player is executing the first exercise event or the objects which are based on the second exercise state in which the player executing the second exercise event based on the first information transmitted and received from the data collection device and delivers the first video to the display device. Accordingly, according to the recording medium according to the application example, it is possible to generate the video including the information related to the exercise event which the player is executing in a game in which the exercise events continuously switch and deliver the video to the display device.

### BRIEF DESCRIPTION OF THE DRAWINGS

The invention will be described with reference to the accompanying drawings, wherein like numbers reference like elements.

FIG. 1 is a diagram illustrating an example of a configuration of a video delivery system according to an embodiment.

FIG. 2 is an explanatory diagram illustrating an overview of the video delivery system according to the embodiment.

FIG. 3 is a diagram illustrating an example of a course used in a triathlon.

FIG. 4 is a diagram illustrating an example of a functional block of a player terminal.

FIG. 5 is a flowchart illustrating an example of a procedure of some processes performed by a processing unit of the player terminal.

FIG. 6 is a flowchart illustrating an example of details of a state determination process according to a first embodiment.

FIG. 7 is a diagram illustrating an example of a functional block of a data collection device.

FIG. 8 is a diagram illustrating examples of objects which are based on determined states.

FIG. 9 is a flowchart illustrating an example of a procedure of some processes performed by the processing unit of the data collection device.

FIG. 10 is a diagram illustrating an example of a functional block of a video generation device.

FIG. 11 is a flowchart illustrating an example of a procedure of some processes performed by a processing unit of the video generation device.

FIG. 12 is a diagram illustrating an example of a video displayed on a display device.

FIG. 13 is a diagram illustrating an example of a video displayed on the display device.

FIG. 14 is a diagram illustrating an example of a video displayed on the display device.

FIG. 15 is a diagram illustrating an example of a video displayed on the display device.

FIG. 16 is a diagram illustrating an example of a video displayed on the display device.

FIG. 17 is a flowchart illustrating an example of a swim determination process according to a first modification example of the state determination process.

FIG. 18 is a flowchart illustrating an example of a transition 1 determination process according to the first modification example of the state determination process.

FIG. 19 is a flowchart illustrating an example of a bike determination process according to the first modification example of the state determination process.

FIG. 20 is a flowchart illustrating an example of a transition 2 determination process according to the first modification example of the state determination process.

FIG. 21 is a flowchart illustrating an example of a run determination process according to the first modification example of the state determination process.

FIG. 22 is a flowchart illustrating an example of a swim determination process according to a second modification example of the state determination process.

FIG. 23 is a flowchart illustrating an example of a transition 1 determination process according to the second modification example of the state determination process.

FIG. 24 is a flowchart illustrating an example of a bike determination process according to the second modification example of the state determination process.

FIG. 25 is a flowchart illustrating an example of a transition 2 determination process according to the second modification example of the state determination process.

FIG. 26 is a flowchart illustrating an example of a run determination process according to the second modification example of the state determination process.

FIG. 27 is a diagram illustrating an example of registration of a position for a third modification example of the state determination process.

FIG. 28 is a flowchart illustrating the third modification example of the state determination process.

### DESCRIPTION OF EXEMPLARY EMBODIMENTS

Hereinafter, preferred embodiments of the invention will be described in detail with reference to the drawings. The embodiments to be described below do not inappropriately limit content of the invention described in the appended claims. All of the configurations to be described below are not prerequisite configurations of the invention.

Hereinafter, a video delivery system that delivers a video of players executing a triathlon as a game including a plurality of game events (exercise events) will be exemplified.

### 1. Embodiment

### 1-1. Configuration of Video Delivery System

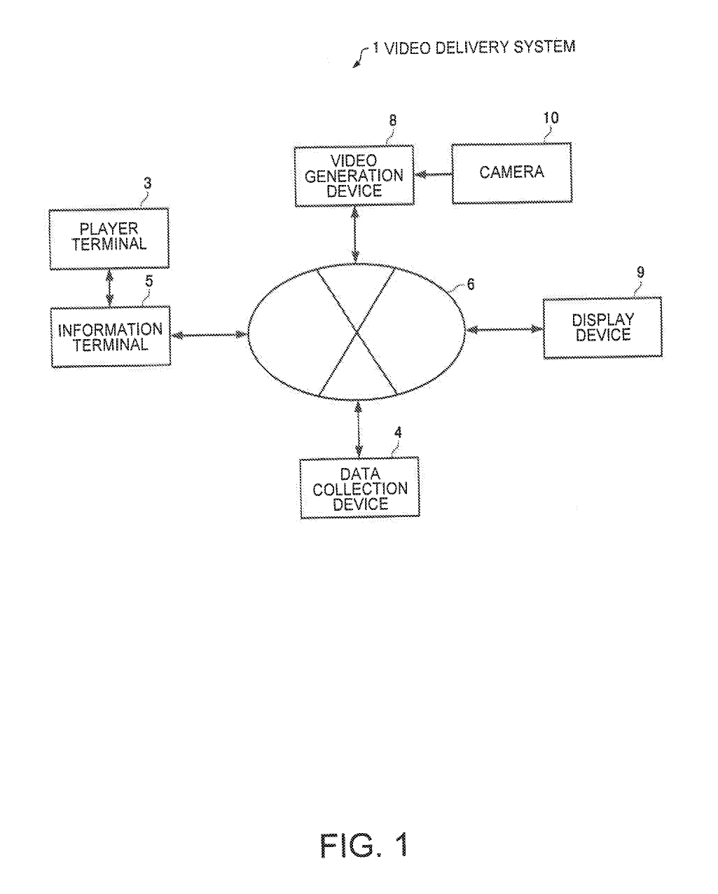

FIG. 1 is a diagram illustrating an example of a configuration of a video delivery system 1 according to an embodiment. As illustrated in FIG. 1, the video delivery system 1 is configured to include a player terminal 3, a data collection device 4, and a video generation device 8. The data collection device 4 and the video generation device 8 is connected to a network 6 configured to include, for example, the Internet, a Local Area Network (LAN), and a television broadcast line (terrestrial channel line, a satellite channel line, or the like). The video delivery system 1 may include one or a plurality of display devices 9 or one or a plurality of cameras 10.

In the embodiment, each of a plurality of players 2 performs a triathlon carrying the player terminal 3 (which is an example of an “electronic device”). The triathlon is configured to include three game events (exercise events), a swim (swimming), a bike (bicycle), and a run (running). The players 2 execute the exercise events in a procedure of the swim, the bike, and the run.

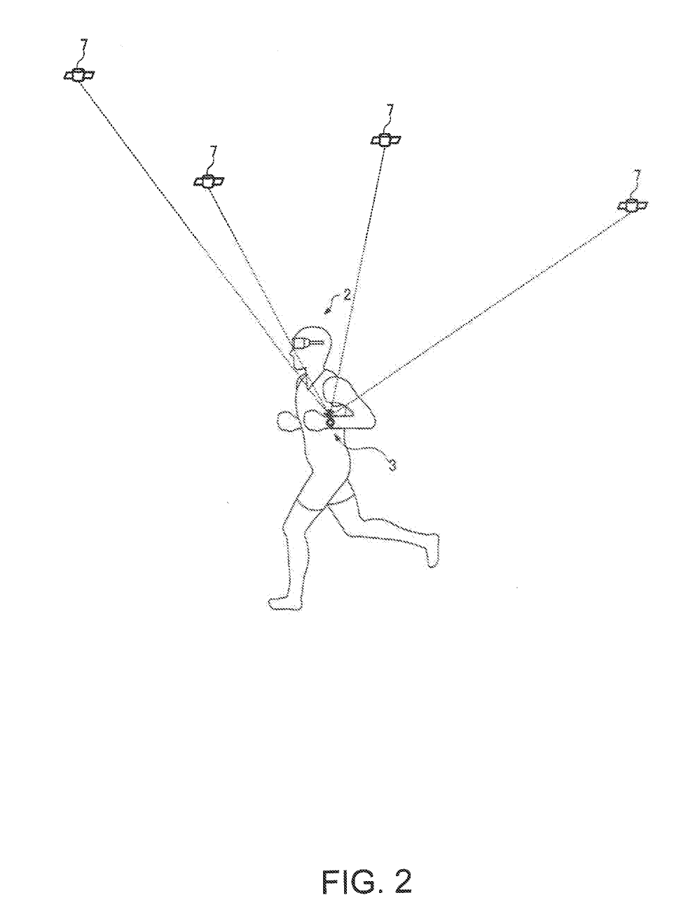

As illustrated in FIG. 2, in the embodiment, the player terminal 3 is a wrist type (watch type) electronic device and is worn on a wrist or the like of the player 2. FIG. 2 is a diagram when the player 2 is running.

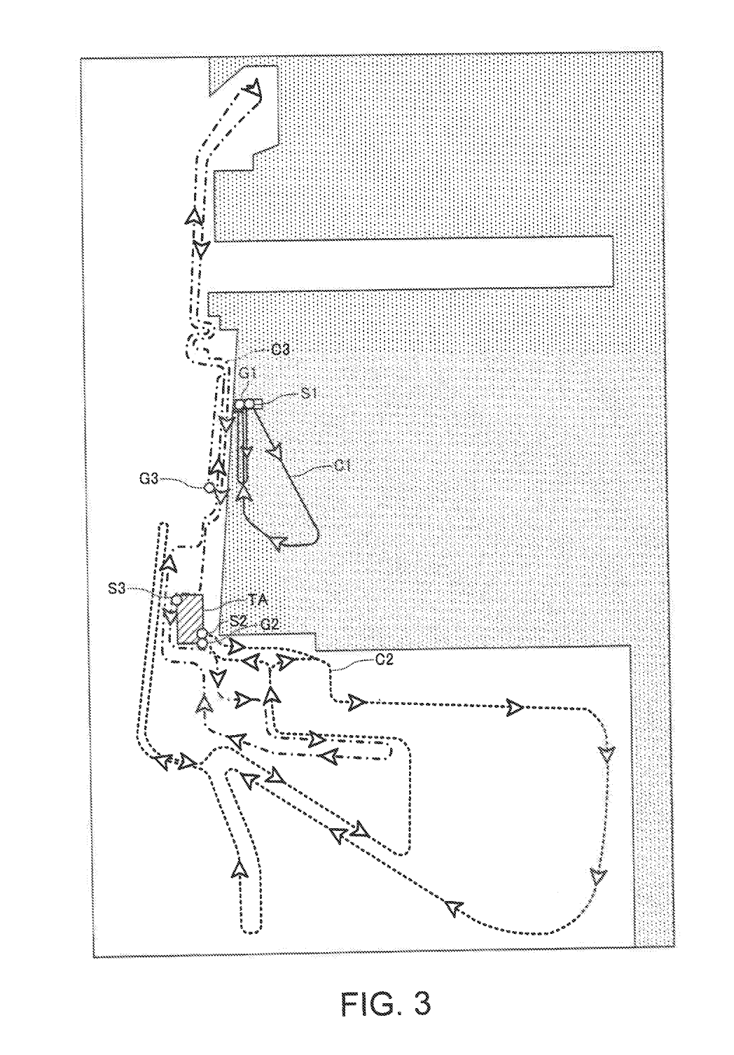

FIG. 3 is a diagram illustrating an example of a course used in the triathlon. A solid line C1 indicates a course of the swim, a dotted line C2 indicates a course of the bike, and a one-dot chain line C3 indicates a course of the run. S1 indicates a start point of the swim (a start point of the triathlon), S2 indicates a start point of the bike, and S3 indicates a start point of the run. G1 indicates a goal point of the swim, G2 indicates a goal point of the bike, and G3 indicates a goal point of the run (a goal point of the triathlon). TA indicates a transition area.

In the triathlon, for example, an elapsed time in which the player 2 starts from the start point S1 of the swim and then passes the start point 82 of the bike is considered to be a time necessary for the swim (a swim time), an elapsed time in which the player 2 passes the start point S2 of the bike and then passes the start point S3 of the run is considered to be a time necessary for the bike (a bike time), and an elapsed time in which the player 2 passes the start point S3 of the run and then passes the goal point G3 of the run is considered to be a time necessary for the run (a run time). In this case, an elapsed time (transition 1 time) in which the player 2 passes the goal point G1 of the swim and then passes the start point S2 of the bike, that is, a sum of a time in which the player 2 moves from the goal point G1 of the swim to the transition area TA, a time necessary for the player 2 to change clothes or the like (for example, the player wears bike shoes, a helmet, and sunglasses, and the like) in the transition area TA, and a time in which the player 2 moves up to the start point S2 of the bike, is included in the swim time. Similarly, an elapsed time (transition 2 time) in which the player 2 passes the goal point G2 of the bike and then passes the start point S3 of the run, that is, a sum of a time in which the player 2 moves from the goal point G2 of the bike to a cloth change place in the transition area TA, a time necessary for changing clothes (for example, the player takes off the helmet, the sunglasses, and the bike shoes, and the like and wears running shoes), and a time in which the player 2 moves up to the start point S3 of the run, is included in the bike time. A sum of the swim time, the bike time, and the run time is a total time.

In the embodiment, the player 2 performs a measurement start operation on the player terminal 3 when the triathlon starts (when the player 2 starts the swim at the start point S1).

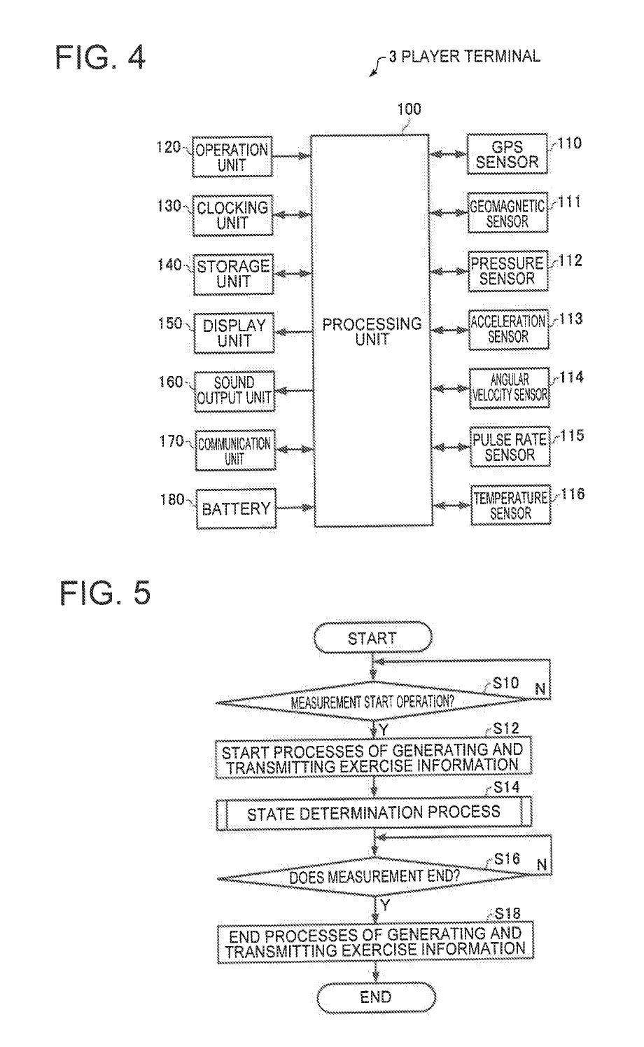

The player terminal 3 contains a clocking unit 130 (see FIG. 4 to be described below). An elapsed time from the measurement start operation, that is, a total elapsed time Ttotal from start of the triathlon by the player 2, is measured. Information regarding the measured total elapsed time Ttotal is displayed on a display unit 150 (see FIG. 4) or the like in sequence (in real time).

The player terminal 3 determines a plurality of states including a state “swim” (an example of a “first exercise event”) in which the player 2 is swimming (an example of a “first exercise state”), a state “bike” (an example of a “second exercise event”) in which the player 2 is biking (an example of a “second exercise state”), a state “run” (an example of a “third exercise event”) in which the player 2 is running (an example of a “third exercise state”) based on a satellite signal transmitted from a Global Positioning System (GPS) satellite 7 (an example of “positional information satellite”). In particular, in the embodiment, the player terminal 3 determines the plurality of states of the player 2 based on positional information obtained based on a satellite signal transmitted from the GPS satellite 7 and at least one of an output signal of an acceleration sensor 113 (see FIG. 4) and an output signal of a pressure sensor 112 (see FIG. 4). In the embodiment, the plurality of states determined by the player terminal 3 include a state “transition 1” in which “swim” is transitioning to “bike” (an example of a “first transition state”) and a state “transition 2” in which “bike” is transitioning to “run” (an example of a “second transition state”). That is, in the embodiment, the player terminal 3 determines five states, “swim”, “transition 1”, “bike”, “transition 2”, and “run”.

The player terminal 3 measures an elapsed time Tswim from start to end of “swim”, an elapsed time Ttran1 from start to end of “transition 1”, an elapsed time Tbike from start to end of “bike”, an elapsed time Ttran2 from start to end of “transition 2”, and an elapsed time Trun from start to end of “run”, and then displays information regarding each of the determined states or the elapsed time of each of the measured states on the display unit 150 or the like in sequence (in real time).

The player terminal 3 generates information regarding a speed, a pace, a distance, a trajectory, a pulse rate, a heart rate, a pitch (running pitch), a stride (running stride), a swim stroke, and the like of the player 2 based on output signals of various sensors.

The player terminal 3 stores exercise information (the total elapsed time Ttotal, the elapsed times Tswim, Ttran1, Tbike, Ttran2, and Trun, the determined states, the speed, the pace, the distance, the trajectory, the pulse rate, the heart rate, the pitch, the stride, the swim stroke, and the like) regarding the player 2 in a contained storage unit 140 (see FIG. 4) in sequence while the player 2 is executing the triathlon.

In the embodiment, the player 2 performs a measurement end operation on the player terminal 3 when the player 2 ends the triathlon (when the player 2 passes the goal point G3).

When the measurement end operation is operated, the player terminal 3 ends the determination process for the five states, the measurement process for the total elapsed time Ttotal, the measurement processes for “swim”, “transition 1”, “bike”, “transition 2”, and “run” of the states, and the measurement processes for the elapsed times Tswim, Ttran1, Tbike, Ttran2, and Trun and stores the total elapsed time Ttotal and the elapsed times Tswim, Ttran1, Tbike, Ttran2, and Trun in the contained storage unit 140 (see FIG. 4). The total elapsed time Ttotal stored in the storage unit 140 is equivalent to the above-described “total time”. A sum of the elapsed times Tswim and Ttran1 stored in the storage unit 140 is equivalent to the above-described “swim time”. A sum of the elapsed times Tbike and Ttran2 stored in the storage unit 140 is equivalent to the above-described “bike time”. The elapsed time Trun stored in the storage unit 140 is equivalent to the above-described “run time”. The elapsed time Ttran1 stored in the storage unit 140 is equivalent to the above-described “transition 1 time”. The elapsed time Ttran2 stored in the storage unit 140 is equivalent to the above-described “transition 2 time”.

In the embodiment, the player terminal 3 can be connected to the network 6 via the information terminal 5. Then, after the player 2 starts the triathlon, the player terminal 3 transmits the exercise information regarding the player 2 stored in the storage unit 140 of the player terminal 3 to the data collection device 4 via the information terminal 5 and the network 6. The information terminal 5 may be, for example, a smartphone or a personal computer.

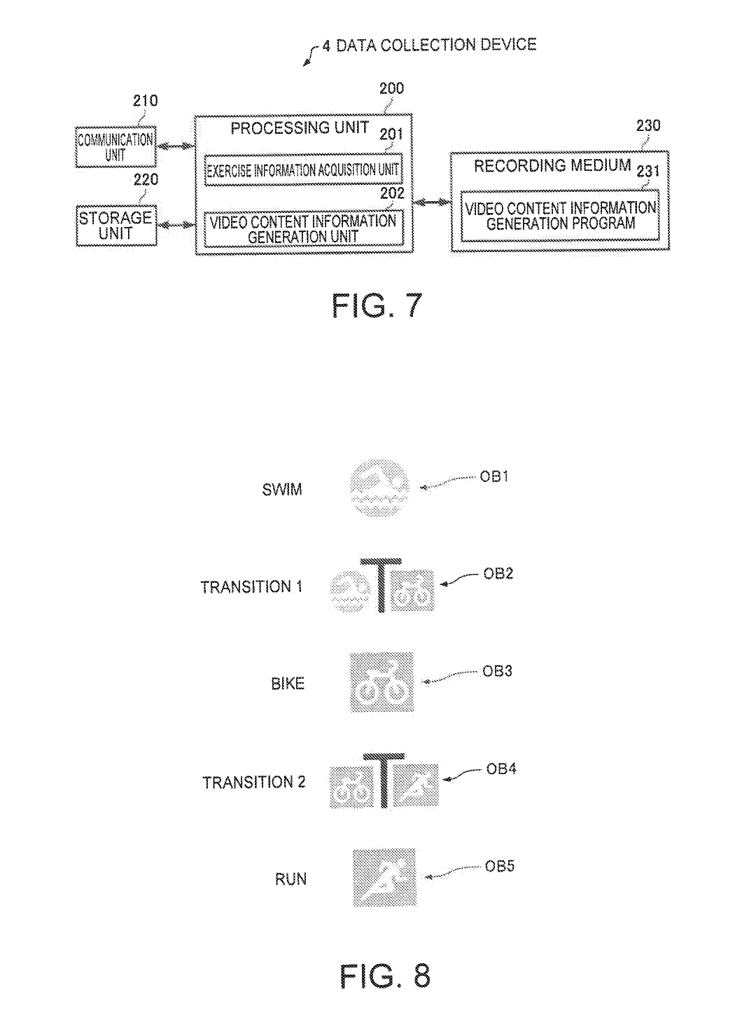

The data collection device 4 receives the exercise information regarding the player 2 transmitted from the player terminal 3 via the network 6 and stores (reserves) the received exercise information in the storage unit 220 or a recording medium 230 (see FIG. 7). The data collection device 4 stores various kinds of information regarding the triathlon (map information or weather information regarding the course of the triathlon, object information indicating each of the states of “swim”, “transition 1”, “bike”, “transition 2”, and “run”, costume information regarding the player 2, and the like) in the storage unit 220 or the recording medium 230. Then, the data collection device 4 generate video content information in response to a request from the video generation device 8 based on various kinds of information or the exercise information received and stored in the storage unit 220 or the recording medium 230. In particular, in the embodiment, the data collection device 4 generates first video content information (an example of “first information”) including information related to an object which is based on the determined states (the states of “swim”, “transition 1”, “bike”, “transition 2”, and “run”) based on the exercise information stored in the storage unit 220 or the recording medium 230. The first video content information may include information related to the elapsed times Tswim, Ttran1, Tbike, Ttran2, and Trun in the determined states. The data collection device 4 may generate second video content information (an example of “second information”) including information related to a graph that chronologically shows a change in an exercise situation of the player 2 based on the exercise information stored in the storage unit 220 or the recording medium 230. Then, the data collection device 4 transmits the generated video content information to the video generation device 8 via the network 6. The data collection device 4 may be, for example, a server that is owned by a game organizer of the triathlon, a maker of the player terminal 3, or the like.

The video generation device 8 generates live broadcasting videos in television broadcast, Internet broadcast, or the like based on the video information regarding the triathlon in which the plurality of players 2 participate and which is photographed by one or the plurality of cameras 10 and the video content information generated by the data collection device 4. In particular, in the embodiment, the video generation device 8 receives the first video content information from the data collection device 4 via the network 6 and generates a first video including an object which is based on the determined state based on the received first video content information. The first video may be, for example, a video including a moving image of the triathlon and an object which is based on the determined player 2 state. The video generation device 8 may receive the second video content information from the data collection device 4 via the network 6 and generate a second video including a graph that chronologically shows a change in an exercise situation of the player 2 based on the received second video content information. The second video may be, for example, a video including a moving image of the triathlon and a graph that chronologically shows a change in an exercise situation of the player 2. Then, the video generation device 8 delivers the generated first or second video to one or the plurality of display devices 9 via the network 6. The video generation device 8 may be a server that is owned by a broadcasting service provider, a video delivery service provider, or the like.

The display device 9 receives the video (the first or second video or the like) generated by the video generation device 8 from the video generation device 8 via the network 6 and displays the received video on a display unit (not illustrated). The display device 9 is a display device capable of performing communication (bidirectional communication) and transmits various signals (signal for requesting display of data information (for example, information transmitted through data broadcast) or a signal for selecting the player 2 who is a data information display target) to the video generation device 8 via the network 6. Then, the video generation device 8 acquires the video content information in accordance with the various signals from the data collection device 4, generates a video, and delivers the video to the display device 9. Then, viewers view the videos of the triathlon displayed on the display device 9. The display device 9 may be a television receiver or the like.

### 1-2. Configuration and Process of Player Terminal

FIG. 4 is a diagram illustrating an example of a functional block of the player terminal 3. As illustrated in FIG. 4, the player terminal 3 is configured to include a processing unit 100, a GPS sensor 110, a geomagnetic sensor 111, a pressure sensor 112, an acceleration sensor 113, an angular velocity sensor 114, a pulse rate sensor 115, a temperature sensor 116, an operation unit 120, a clocking unit 130, a storage unit 140, a display unit 150, a sound output unit 160, a communication unit 170, and a battery 180. Here, in the configuration of the player terminal 3, some of the constituent elements may be deleted or changed, or other constituent elements may be added.

The GPS sensor 110 generates positional information based on a satellite signal transmitted from the GPS satellite 7. For example, the GPS sensor 110 may be a GPS receiver that receives the satellite signal transmitted from the GPS satellite 7 with an antenna (not illustrated), demodulates a navigation message from the satellite signal, and generates and outputs positioning data (data of a latitude, a longitude, an altitude, a velocity vector, and the like) which is positional information indicating the position or the like of the player terminal 3 based on the navigation message.

The geomagnetic sensor 111 is a sensor that detects and outputs a magnetic field (geomagnetic field) of the earth and, for example, generates and outputs a geomagnetic signal indicating a magnetic flux density in three axial directions perpendicular to each other. As the geomagnetic sensor 111, for example, a magnet resistive (MR) element, a magnet impedance (MI) element, or a Hall element is used.

The pressure sensor 112 is a sensor that detects and outputs a surrounding pressure (an atmospheric pressure, a hydraulic pressure, a wind pressure, or the like) and includes, for example, a pressure-sensitive element of a scheme (vibration scheme) of using a change in a resonance frequency of a resonator element. The pressure-sensitive element is, for example, a piezoelectric vibrator formed of a piezoelectric material such as quartz crystal, lithium niobate, or lithium tantalate. For example, a tuning fork type vibrator, a dual tuning fork type vibrator, or an AT vibrator (thickness shear vibrator), or a SAW resonator is applied. Alternatively, the pressure sensor 112 may be a MEMS type pressure sensor manufactured using a semiconductor manufacturing technology. For example, the pressure sensor 112 includes a diaphragm unit that is flexural-deformed by a hydraulic pressure and a strain detection element that detects flexural deformation of the diaphragm unit. The diaphragm unit is formed of, for example, silicon. The strain detection element is, for example, a piezoresistive element.

The acceleration sensor 113 detects acceleration in each of triaxial directions intersecting each other (ideally, perpendicular to each other) and outputs a signal (acceleration signal) according to the magnitude and direction of the detected triaxial acceleration.

The angular velocity sensor 114 detects an angular velocity in each of triaxial directions intersecting each other (ideally, perpendicular to each other) and outputs a signal (angular velocity signal) according to the magnitude and direction of the detected triaxial angular velocity.

At least one of the signal (the pressure signal) output by the pressure sensor 112, the signal (the acceleration signal) output by the acceleration sensor 113, and the signal (the angular velocity signal) output by the angular velocity sensor 114 may be used to correct information regarding a position included in positioning data by the GPS sensor 110.

The pulse rate sensor 115 is a sensor that generates and outputs a signal indicating a pulse rate of the player 2 and includes, for example, a light source such as a light-emitting diode (LED) light source that emits measurement light with an appropriate wavelength to a hypodermic blood vessel and a light-receiving element that detects a change in the intensity of light generated from the blood vessel according to the measurement light. For example, by processing an intensity change wavelength (pulse wave) of the light through a known scheme such as frequency analysis, it is possible to measure a pulse rate (the number of pulsations per minute). Since a heart rate (the number of beats per minute) is substantially the same as the pulse rate as long as there is no arrhythmia, pulse deficit, or the like, the pulse rate sensor 115 can measure a heart rate. As the pulse rate sensor 115, an ultrasonic sensor that detects contraction of blood vessels by ultrasonic waves and measures a pulse rate (heart rate) may be adopted or a sensor that flows a weak current in a body from an electrode and measures a pulse rate (heart rate) may be adopted instead of a photoelectric sensor including a light source and a light-receiving element.

The temperature sensor 116 is a sensor that outputs a signal according to a surrounding temperature (temperature signal).

The operation unit 120 is configured to have, for example, a button, a key, a microphone, a touch panel, a sound recognition function (using a microphone (not illustrated)), and an action detection function (using the acceleration sensor 113 or the like) and performs processes of converting an instruction from the player 2 into an appropriate signal and transmitting the signal to the processing unit 100.

The clocking unit 130 is configured with, for example, a real time clock (RTC) IC, generates time data such as year, month, day, hour, minute, and second, and transmits the time data to the processing unit 100. The time data may be appropriately corrected based on time information included in positioning data by the GPS sensor 110.

The storage unit 140 is configured with a plurality of integrated circuit (IC) memories and includes, for example, a read-only memory (ROM) that stores data such as a program, a random access memory (RAM) that serves as a work area of the processing unit 100, and a recording medium (a recording medium from which data can be read by the player terminal 3 (an example of a computer) such as a memory card that stores a program, data, and the like. The ROM or the recording medium stores various programs used for the processing unit 100 to perform various calculation processes or control processes, various program used to realize application functions, various kinds of data, and the like.

The player terminal 3 may receive various programs and various kinds of data stored in a recording medium (an optical disc (a CD or a DVD), a magneto-optical disc (MO), a magnetic disk, a hard disk, a magnetic tape, or the like) or a storage unit included in the data collection device 4 via the information terminal 5 and the network 6 and may store the received various programs and various kinds of data in the storage unit 140 (RAM).

The display unit 150 is configured with, for example, a liquid crystal display (LCD), an organic electroluminescence (EL) display, an electrophoretic display (EPD), or a touch panel display and displays various images in response to an instruction from the processing unit 100. As the display unit 150, a head-mounted display (HMD) installed to be separate from the player terminal 3 can also be used.

The sound output unit 160 is configured with, for example, a speaker, a buzzer, or a vibrator and generates various sounds (including vibration) in response to an instruction from the processing unit 100. As the sound output unit 160, a bone conduction device installed to be separate from the player terminal 3 can also be used.

The communication unit 170 performs various kinds of control to establish communication between the player terminal 3 and the information terminal 5. The communication unit 170 is configured with, for example, a transceiver corresponding to a short-range wireless communication standard such as Bluetooth (registered trademark) (including Bluetooth Low Energy (BTLE)), wireless fidelity (Wi-Fi) (registered trademark), Zigbee (registered trademark), near field communication (NFC), or ANT+ (registered trademark). The communication unit 170 is configured to include a connector corresponding to a communication bus standard such as Universal Serial Bus (USB).

The battery 180 supplies power to each unit included in the player terminal 3 and is, for example, a charging battery. For example, a non-contact charging scheme or a contact charging scheme (charging in which a cradle or the like is used) can be applied as the charging scheme of the battery 180. The battery 180 may be an interchangeable battery or may be a solar power generation battery.

The processing unit 100 (processor) is configured with, for example, a microprocessing unit (MPU), or a digital signal processor (DSP), an application specific integrated circuit (ASIC). The processing unit 100 performs various processes based on programs stored in the storage unit 140 and signals input from the operation unit 120. The processes performed by the processing unit 100 include data processing on signals output by the GPS sensor 110, the geomagnetic sensor 111, the pressure sensor 112, the acceleration sensor 113, the angular velocity sensor 114, the pulse rate sensor 115, the temperature sensor 116, and the clocking unit 130, a display process of causing the display unit 150 to display an image, sound output processes of causing the sound output unit 160 to output a sound, communication processes of communicating with the information terminal 5 via the communication unit 170, and a power control process of supplying power from the battery 180 to each unit.

In particular, in the embodiment, as one of the data processing, the processing unit 100 performs a process of measuring an elapsed time (the total elapsed time Ttotal) elapsed from reception of a signal indicating a measurement start operation from the operation unit 120 based on a signal output by the clocking unit 130.

As one of the data processing, the processing unit 100 performs a process of determining the plurality of states of the player 2, “swim”, “transition 1”, “bike”, “transition 2”, and “run” based on positioning data (positional information obtained based on a satellite signal transmitted from the GPS satellite 7) generated and output by the GPS sensor 110 and at least one of a signal output by the pressure sensor 112 and a signal output by the acceleration sensor 113.

Generally, in the swim, since strokes of the arms of the player 2 are regular (have periodicity), waveforms of signals output by the acceleration sensor 113 are regular (have periodicity). A speed (movement speed) at which the player 2 is swimming is within a predetermined speed range (for example, about 3 km/h). Further, since a state in which the arms of the player 2 are in the air and a state in which the arms of the player 2 are in the water are alternately repeated, the pressure sensor 112 detects the atmospheric pressure and the hydraulic pressure. In the transition 1, since the player 2 changes clothes or the like, the position of the player 2 is not substantially changed and the player 2 nearly stops (a movement speed is zero). In the bike, a speed (movement speed) at which the player 2 is biking is equal to or greater than a predetermined speed (for example, 20 km/h). Since the player 2 moves against wind, the pressure sensor 112 detects a wind pressure. In the transition 2, since the player 2 is changing clothes or the like, the position of the player 2 is not substantially changed and the player 2 nearly stops (a movement speed is zero). In the run, since arm swinging of the player 2 is regular (have periodicity), waveforms of signals output by the acceleration sensor 113 are regular (have periodicity). A speed (movement speed) at which the player 2 is running is within a predetermined speed range (for example, 8 km/h to 20 km/h).

Accordingly, the processing unit 100 may calculate a movement speed of the player 2 based on the positioning data (positional information) generated and output by the GPS sensor 110, determine whether the waveforms of the signals output by the acceleration sensor 113 have the periodicity, detect a change in the pressure based on the signal output by the pressure sensor 112, determine whether the movement speed of the player 2 and the waveforms of the signals output by the acceleration sensor 113 have the periodicity, and determine the plurality of states of the player 2, “swim”, “transition 1”, “bike”, “transition 2”, and “run” based on the change in the pressure.

As one of the data processing, the processing unit 100 performs a process of calculating a time necessary for each of the plurality of states of the player 2, “swim”, “transition 1”, “bike”, “transition 2”, and “run”. That is, the processing unit 100 performs a process of measuring the elapsed time Tswim of the state “swim”, the elapsed time Ttran1 of the state “transition 1”, the elapsed time Tbike of the state “bike”, the elapsed time Ttran2 of the state “transition 2”, and the elapsed time Trun of the state “run” based on the signals output by the clocking unit 130.

As one of the data processing, the processing unit 100 performs a process of generating information regarding the speed, the pace, the distance, the trajectory, the pulse rate, the heart rate, the pitch (running pitch), the stride (running stride), the swim stroke, and the like of the player 2 after reception of signals indicating measurement start operations from the operation unit 120 based on the signals output by the GPS sensor 110, the geomagnetic sensor 111, the pressure sensor 112, the acceleration sensor 113, the angular velocity sensor 114, the pulse rate sensor 115, the temperature sensor 116, and the clocking unit 130.

For example, the processing unit 100 generates information regarding the movement speed (speed), the pace, the distance, and the trajectory of the player 2 based on the positioning data (positional information) output by the GPS sensor 110. The processing unit 100 generates information regarding a pulse rate and a heart rate based on signals output by the pulse rate sensor 115. The processing unit 100 generates information regarding the pitch (running pitch) based on a signal output by the acceleration sensor 113 or a signal output by the angular velocity sensor 114. The processing unit 100 generates information regarding the stride (running stride) from the information regarding the distance and the pitch. The processing unit 100 generates information regarding the swim stroke (stroke speed) based on a temporal change of a water depth obtained from a signal output by the pressure sensor 112.

As one of the data processing, the processing unit 100 performs a process of storing exercise information regarding the player 2 (the total elapsed time Ttotal, the elapsed times Tswim, Ttran1, Tbike, Ttran2, and Trun, the determined states, the speed, the pace, the distance, the trajectory, the pulse rate, the heart rate, the pitch, the stride, the swim stroke, and the like) from reception of a signal indicating a measurement start operation from the operation unit 120 to reception of a signal indicating a measurement end operation in the storage unit 140.

As one of the data processing, when a signal indicating a measurement end operation is received from the operation unit 120, the processing unit 100 ends the measurement process of the total elapsed time Ttotal, the determination process for the plurality of states, “swim”, “transition 1”, “bike”, “transition 2”, and “run”, and the measurement process for the elapsed times Tswim, Ttran1, Tbike, Ttran2, and Trun of the states and performs a process of storing the total elapsed time Ttotal and the elapsed times Tswim, Ttran1, Tbike, Ttran2, and Trun (final times) in the storage unit 140 in a temporal order.

As one of the communication processes, the processing unit 100 performs a process of transmitting the exercise information regarding the player 2 stored in the storage unit 140 to the data collection device 4 via the communication unit 170 and the information terminal 5 in a temporal order from reception of a signal indicating the measurement start operation to reception of a signal indicating the measurement end operation from the operation unit 120.

As one of the display processes, the processing unit 100 may perform a process of causing the display unit 150 to display at least one of the plurality of states “swim”, “transition 1”, “bike”, “transition 2”, and “run” of the player 2. In this case, the display unit 150 functions as a notification unit that notifies of the state determined by the processing unit 100.

As one of the display processes, the processing unit 100 may perform a process of causing the display unit 150 to display at least some of the exercise information regarding the player 2.

As one of the sound output processes, the processing unit 100 may perform a process of outputting at least one of the plurality of states “swim”, “transition 1”, “bike”, “transition 2”, and “run” of the player 2 as a sound to the sound output unit 160. In this case, the sound output unit 160 functions as a notification unit that notifies of the state determined by the processing unit 100.

As one of the sound output processes, the processing unit 100 may perform a process of outputting at least some of the exercise information regarding the player 2 as sounds to the sound output unit 160.

As one of the communication processes, the processing unit 100 may perform a process of transmitting at least one of the plurality of states “swim”, “transition 1”, “bike”, “transition 2”, and “run” of the player 2 to the information terminal 5 via the communication unit 170. In this case, the communication unit 170 functions as a notification unit that notifies of the state determined by the processing unit 100.

FIG. 5 is a flowchart illustrating an example of a procedure of some of the processes performed by the processing unit 100 of the player terminal 3. The processing unit 100 of the player terminal 3 performs a process in the procedure of the flowchart of FIG. 5 by executing a program stored in the storage unit 140 (the recording medium, the ROM, or the RAM).

As illustrated in FIG. 5, the processing unit 100 first stands by until receiving a signal indicating a measurement start operation from the operation unit 120 (N in step S10). When the signal indicating the measurement start operation is received (Y in S10), the processing unit 100 starts a process of generating the exercise information regarding the player 2 and a process of transmitting the exercise information to the data collection device 4 (step S12).

Subsequently, the processing unit 100 performs a state determination process of determining the player 2 state (step S14). In the embodiment, the processing unit 100 performs the process of determining the plurality of states of the player 2, “swim”, “transition 1”, “bike”, “transition 2”, and “run” based on the positioning data (positional information) generated and output by the GPS sensor 110, the signal output by the acceleration sensor 113, and the signal output by the pressure sensor 112. The details of the state determination process will be described below.

Subsequently, the processing unit 100 stands by until receiving a signal indicating the measurement end operation from the operation unit 120 (N in step S16). When the processing unit 100 receives the signal indicating the measurement end operation (Y in step S16), the processing unit 100 ends the process of generating the exercise information regarding the player 2 and the process of transmitting the exercise information regarding the player 2 to the data collection device 4 (step S18).

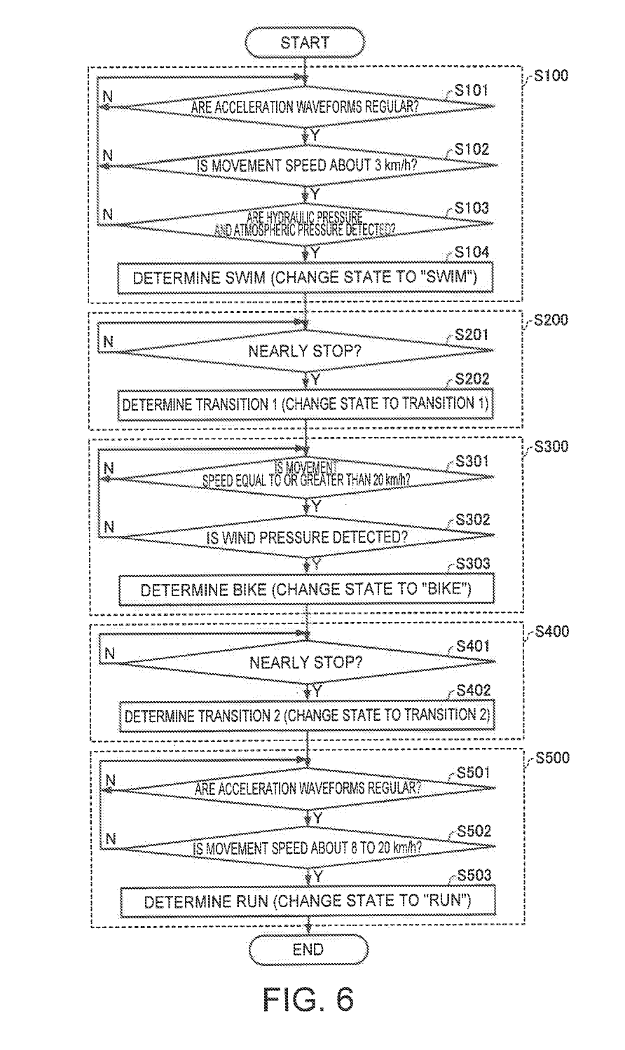

FIG. 6 is a flowchart illustrating a detailed example of the state determination process (the process of step S14 in FIG. 5).

As illustrated in FIG. 6, in the embodiment, the processing unit 100 performs a swim determination process (S100), a transition 1 determination process (step S200), a bike determination process (step S300), a transition 2 determination process (step S400), and a run determination process (step S500).

As described above, in the swim, the strokes of the arms of the player 2 are regular (have regularity), the speed at which the player 2 is swimming is within the predetermined speed range (for example, about 3 km/h), and the state in which the arms of the player 2 are in the air and the state in which the arms of the player 2 are in the water are alternately repeated. Accordingly, when the acceleration waveforms (the waveforms output by the acceleration sensor 113) are regular (have regularity) (Y in step S101), a movement speed obtained by differentiating the position of the player terminal 3 included in the positioning data of the GPS sensor 110 is about 3 km/h (Y in step S102), and the hydraulic pressure and the atmospheric pressure are detected based on signals output by the pressure sensor 112 (Y in step S103) in the swim determination process (step S100), the processing unit 100 determines that the player 2 is swimming and changes the player 2 state from an indeterminate state to “swim” (step S104).

When a period at which a voltage of a signal output by the acceleration sensor 113 matches a threshold Vt1 is substantially constant (within a predetermined range) for a predetermined time, the processing unit 100 may determine that the acceleration waveforms are regular. The threshold Vt1 may be appropriately determined. When the movement speed of the player terminal 3 is equal to or greater than 3 km/h−α1 and equal to or less than 3 km/h+α2, the processing unit 100 may determine that speed is about 3 km/h. Here, α1 and α2 may be appropriately determined. The hydraulic pressure is greater than the atmospheric pressure by a predetermined amount. Therefore, when a pressure applied to the player terminal 3 and calculated using a signal output by the pressure sensor 112 is periodically changed and a difference between the maximum value and the minimum value is equal to or greater than a threshold Pt1, the processing unit 100 may determine that the hydraulic pressure and the atmospheric pressure are detected. The threshold Pt1 may be appropriately set.

As described above, in the transition 1, the position of the player 2 is not substantially changed since the player 2 is changing clothes or the like. Accordingly, when the movement speed of the player terminal 3 is nearly zero (the player 2 nearly stops) (Y in step S201) in the transition 1 determination process (step S200), the processing unit 100 determines that the player 2 is in the transition 1 state and changes the player 2 state from “swim” to “transition 1” (step S202).

When the movement speed of the player terminal 3 is equal to or less than β1, the processing unit 100 may determines that the player 2 nearly stops. β1 may be appropriately determined.

As described above, in the bike, the speed at which the player 2 is biking is equal to or greater than the predetermined speed (for example, 20 km/h) and the player 2 moves against wind. Accordingly, when the movement speed of the player terminal 3 is equal to or greater than 20 km/h (Y in step S301) and the wind pressure is detected based on the signal output by the pressure sensor 112 (Y in step S302) in the bike determination process (step S300), the processing unit 100 determines that the player is biking and changes the player 2 state from “transition 1” to “bike” (step S303).

As described above, in the transition 2, the position of the player 2 is not substantially changed since the player 2 is changing clothes or the like. Accordingly, when the movement speed of the player terminal 3 is nearly zero (the player 2 nearly stops) (Y in step S401) in the transition 2 determination process (step S400), the processing unit 100 determines that the player 2 is in the transition 2 state and changes the player 2 state from “bike” to “transition 2” (step S402).

As described above, in the run, arm swinging of the player 2 is regular (has regularity) and the speed at which the player 2 is running is within the predetermined speed range (for example, 8 km/h to 20 km/h). Accordingly, when the acceleration waveforms (the waveforms output by the acceleration sensor 113) are regular (have regularity) (Y in step S501) and the movement speed of the player terminal 3 is 8 km/h to 20 km/h (Y in step S502) in the run determination process (step S500), the processing unit 100 determines that the player 2 is running and changes the player 2 state from “transition 2” to “run” (step S503).

### 1-3. Configuration and Process of Data Collection Device

FIG. 7 is a diagram illustrating a functional block of the data collection device 4. As illustrated in FIG. 7, the data collection device 4 is configured to include a processing unit 200, a communication unit 210, a storage unit 220, and a recording medium 230. Here, in the configuration of the data collection device 4, some of the constituent elements may be deleted or changed, or other constituent elements may be added.

The storage unit 220 is configured with, for example, a plurality of IC memories and includes a ROM that stores data or a program used for the processing unit 200 to perform various calculation processes or control processes and a RAM that serves as a work area of the processing unit 200.

The recording medium 230 is a recording medium which can be read by the data collection device 4 (an example of a computer) and is, for example, an optical disc (a CD or a DVD), a magneto-optical disc (MO), a magnetic disk, a hard disk, a magnetic tape, or a memory card. The recording medium 230 stores data or a program used for the processing unit 200 to realize an application function. In particular, in the embodiment, the recording medium 230 stores a video content information generation program 231 used for the processing unit 200 to generate video content information (information related to content necessary to generate a video). The storage unit 220 or the recording medium 230 stores various kinds of information regarding the triathlon (map information or weather information regarding the course of the triathlon, object information indicating each of the states of “swim”, “transition 1”, “bike”, “transition 2”, and “run”, costume information regarding the player 2, and the like).

The data collection device 4 may receive various kinds of data or various programs including the video content information generation program 231 stored in a recording medium of a server (not illustrated) via the network 6 or the like and may store the received various kinds of data or various programs in the storage unit 220 (the RAM).

The communication unit 210 communicates with the plurality of player terminals 3 or the video generation device 8 via the network 6. Specifically, the communication unit 210 receives identification information regarding the player terminals 3 and the exercise information regarding the players 2 from the plurality of player terminals 3. The communication unit 210 receives a request for transmitting video content information or selection information for selecting the player 2 who is a target for which the video content information is generated, from the video generation device 8. The communication unit 210 transmits the video content information in response to the transmission request to the video generation device 8.

The processing unit 200 (the processor) is configured with, for example, an MPU, a DSP, or an ASIC. The processing unit 200 performs various processes based on programs stored in the storage unit 220 or programs stored in the recording medium 230. In particular, in the embodiment, the processing unit 200 functions as an exercise information acquisition unit 201 and a video content information generation unit 202 by executing the video content information generation program 231 stored in the recording medium 230.

The exercise information acquisition unit 201 performs a process of acquiring the exercise information received by the communication unit 210 in sequence and storing the identification information (or the identification information regarding the player 2 carrying the player terminal 3) regarding the player terminal 3 in the storage unit 220 or the recording medium 230.

The video content information generation unit 202 performs a process of generating the video content information based on the exercise information regarding the plurality of players 2 stored in the storage unit 220 or the recording medium 230 and transmitting the generated video content information to the video generation device 8 via the communication unit 210. The video content information generation unit 202 may acquire the selection information received by the communication unit 210, select one or the plurality of players 2 who are targets for which the video content information is generated based on the acquired selection information, and generate the video content information based on the exercise information regarding the selected players 2.

In particular, in the embodiment, the video content information generation unit 202 generates the first video content information including information related to objects which are based on the determined states (“swim”, “transition 1”, “bike”, “transition 2”, and “run”) included in the exercise information regarding the player 2. For example, the video content information generation unit 202 may acquire the selection information from the communication unit 210, select one or the plurality of players 2 based on the acquired selection information, select information related to at least one (an object which is based on the determined state of one or the plurality of players 2) of the plurality of objects associated with the plurality of players 2 from object information stored in the storage unit 220 or the recording medium 230, and generate the first video content information including the selected information. FIG. 8 illustrates examples which are based on the determined states (“swim”, “transition 1”, “bike”, “transition 2”, and “run”). In the example of FIG. 8, an object OB1 which is based on the state “swim” is a figure recalling that the player 2 is swimming. An object OB2 which is based on the state “transition 1” is a figure recalling that the player 2 is transitioning from the swim to the bike. An object OB3 which is based on the state “bike” is a figure recalling that the player 2 is biking. An object OB4 which is based on the state “transition 2” is a figure recalling that the player 2 is transitioning from the bike to the run. An object OB5 which is based on the state “run” is a figure recalling that the player 2 is running. The objects which are based on the determined states are not limited to the figures, but may be, for example, letters.

The video content information generation unit 202 may generate the first video content information that further includes information related to the elapsed times (Tswim, Ttran1, Tbike, Ttran2, and Trun) in the determined states included in the exercise information regarding the player 2.

In the embodiment, the exercise information regarding each player 2 stored in the storage unit 220 or the recording medium 230 includes information related to an exercise situation of the player 2. The video content information generation unit 202 generates the second video content information including information related to a graph that chronologically shows a change in the exercise situation of the player 2 based on the exercise information. For example, the video content information generation unit 202 may acquire the selection information from the communication unit 210, select the player 2 based on the acquired selection information, and generate the second video content information including information related to a graph that chronologically shows a change in the exercise situation of the player 2 based on the selected exercise information regarding the player 2. Here, the exercise situation of the player 2 is, for example, biological information (a heart rate, a pulse rate, or the like) or result information (a pace, a speed, a pitch, a stride, an elapsed time, or the like) regarding the player 2.

For example, the storage unit 220 or the recording medium 230 stores information related to costume (costume information) used by each of the plurality of players 2 in the swim, the bike, the run. The video content information generation unit 202 may store the costume information of the selected player 2 and the map information of an area including the course of the triathlon in, for example, the storage unit 220 or the recording medium 230. The video content information generation unit 202 may generate video content information including information related to positions of the player 2 along the course based on the map information and the exercise information regarding the selected player 2.

For example, the storage unit 220 or the recording medium 230 stores information related to exercise intensity of the plurality of players 2. The video content information generation unit 202 may generate video content information including information related to a fatigue of the player 2 (a recovery term until fatigue from which the player recovers) based on the information related to the exercise intensity and the exercise information regarding the player 2. The fatigue (the recovery time) is calculated from the exercise intensity and an exercise time. The exercise intensity of each player 2 may be determined based on a maximum run speed, a maximum oxygen intake, or the like or may be subjective exercise intensity of each player 2.

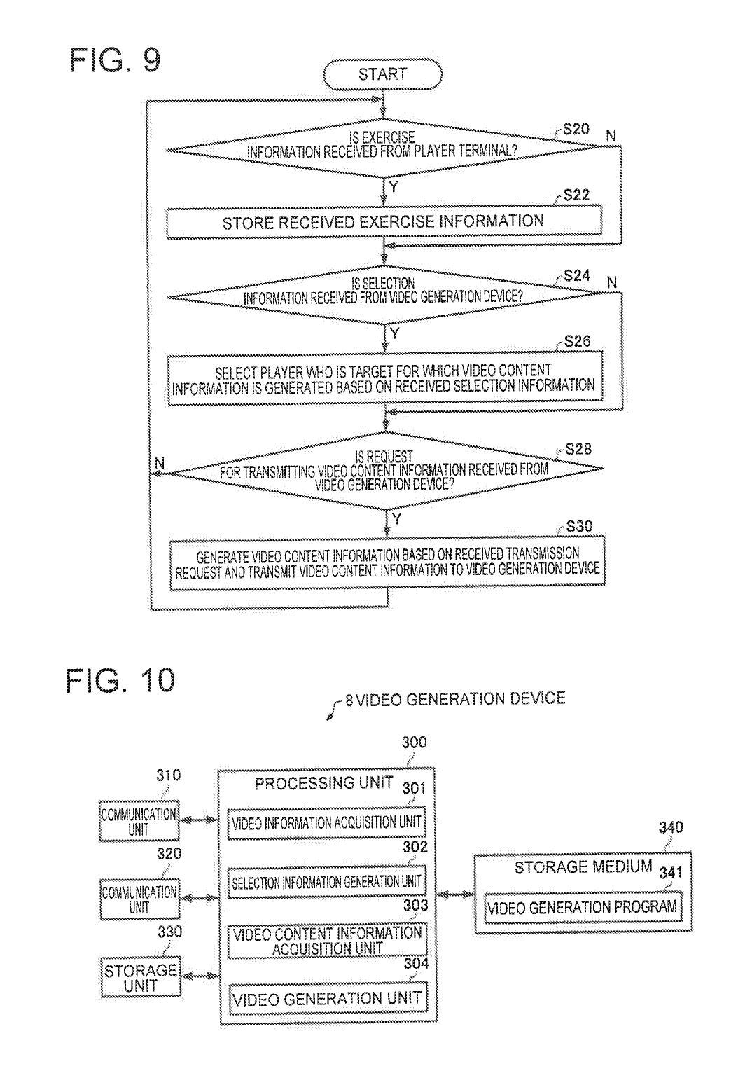

FIG. 9 is a flowchart illustrating an example of a procedure of some processes (video content information generation process) performed by the processing unit 200 of the data collection device 4. The processing unit 200 of the data collection device 4 performs the video content information generation process in the procedure of the flowchart in FIG. 9 by executing the video content information generation program 231 stored in the recording medium 230 or the storage unit 220.

As illustrated in FIG. 9, when the communication unit 210 receives the exercise information regarding the player 2 from any player terminal 3 (Y in step S20), the processing unit 200 first acquires the exercise information received by the communication unit 210 and stores the acquired exercise information in association with the identification information regarding the player terminal 3 (or the identification information regarding the player 2 carrying the player terminal 3) in the storage unit 220 or the recording medium 230 (step S22). Conversely, when the communication unit 210 does not receive the exercise information regarding the player 2 from any player terminal 3 (N in step S20), the processing unit 200 does not perform the process of step S22.

Subsequently, when the communication unit 210 receives the selection information from the video generation device 8 (Y in step S24), the processing unit 200 acquires the selection information received by the communication unit 210 and selects the player 2 who is a target for which the video content information is generated based on the acquired selection information (step S26). Conversely, when the communication unit 210 does not receive the selection information from the video generation device 8 (N in step S24), the processing unit 200 does not perform the process of step S26.

Subsequently, when the communication unit 210 receives a request for transmitting the video content information (a signal requesting transmission of the video content information) from the video generation device 8 (Y in step S28), the processing unit 200 acquires the transmission request received by the communication unit 210, generates the video content information related to the player 2 selected in step S26 based on the acquired transmission request, and transmits the generated video content information to the video generation device 8 (step S30). For example, when the video generation device 8 requests transmission of the first video content information, the processing unit 200 reads the exercise information regarding the player 2 selected in step S26 from the storage unit 220 or the recording medium 230 and generates the first video content information including the information related to an object (for example, at least one of the objects OB1 to OB5 illustrated in FIG. 8) which is based on the determined player 2 state. When the video generation device 8 requests transmission of the second video content information, the processing unit 200 reads at least a part of the exercise information regarding the player 2 selected in step S26 from the storage unit 220 or the recording medium 230 and generates the second video content information including the information related to the graph that chronologically shows a change in the requested exercise situation.

Conversely, when the communication unit 210 does not receive the request for transmitting the video content information from the video generation device 8 (N in step S28), the processing unit 200 does not perform the process of step S30. Then, the processing unit 200 repeatedly performs the processes after steps S20 to S30.

### 1-4. Configuration and Process of Video Generation Device

FIG. 10 is a diagram illustrating an example of a functional block of the video generation device 8. As illustrated in FIG. 10, the video generation device 8 is configured to include a processing unit 300, a communication unit 310, a communication unit 320, a storage unit 330, and a recording medium 340. Here, in the configuration of the video generation device 8, some of the constituent elements may be deleted or changed, or other constituent elements may be added.

the storage unit 330 is configured with, for example, a plurality of IC memories and includes a ROM that stores data or a program used for the processing unit 300 to perform various calculation processes or control processes and a RAM that serves as a work area of the processing unit 300.

The recording medium 340 is a recording medium which can be read by the video generation device 8 (an example of a computer) and is, for example, an optical disc (a CD or a DVD), a magneto-optical disc (MO), a magnetic disk, a hard disk, a magnetic tape, or a memory card. The recording medium 340 stores data or a program used for the processing unit 300 to realize an application function. In particular, in the embodiment, the recording medium 340 stores a video generation program 341 used for the processing unit 300 to generate a video.

The video generation device 8 may receive various kinds of data and various programs including the video generation program 341 stored in a recording medium of a server (not illustrated) via the network 6 or the like and may store the received various kinds of data or various programs in the storage unit 330 (the RAM).

The communication unit 310 communicates with the camera 10 and receives video information of the triathlon imaged by the camera 10.

The communication unit 320 communicates with the data collection device 4 or the display device 9 via the network 6. Specifically, the communication unit 320 receives various signals (a signal for requesting display of data information, a signal for selecting the player 2 who is a data information display target, and the like) transmitted from the display device 9. The communication unit 320 transmits selection information for selecting the player 2 who is a target for which the video content information is generated to the data collection device 4. The communication unit 320 transmits a signal for requesting transmission of the video content information to the data collection device 4 and receives video content information (the first video content information, the second video content information, or the like) in response to the transmission request from the data collection device 4. The communication unit 320 transmits a video of the triathlon to the display device 9.

The processing unit 300 (the processor) is configured with, for example, an MPU, a DSP, or an ASIC. The processing unit 300 performs various processes based on programs stored in the storage unit 330 or programs stored in the recording medium 340. In particular, in the embodiment, the processing unit 300 functions as a video information acquisition unit 301, a selection information generation unit 302, a video content information acquisition unit 303, and a video generation unit 304 by executing the video generation program 341 stored in the recording medium 340.

The video information acquisition unit 301 performs a process of acquiring the video information received by the communication unit 310 in sequence and storing the video information in the storage unit 330 or the recording medium 340.

The selection information generation unit 302 performs a process of generating selection information for selecting one or the plurality of players 2 who are targets for which the data collection device 4 generates the video content information based on a signal (a signal for selecting the player 2 who is a data information display target) transmitted from the display device 9 and received by the communication unit 320 and transmitting the generated selection information to the data collection device 4 via the communication unit 320.

The video content information acquisition unit 303 performs a process of transmitting a signal for requesting transmission of the video content information necessary in the data collection device 4 via the communication unit 320 based on a signal (a signal for requesting display of data information) transmitted from the display device 9 and received by the communication unit 320, acquiring the video content information received by the communication unit 320, and storing the video content information in the storage unit 330 or the recording medium 340.

The video generation unit 304 performs a process of generating a video based on the video information and the video content information stored in the storage unit 330 or the recording medium 340 and delivering the generated video to the display device 9 via the communication unit 320.

In particular, in the embodiment, the first video content information stored in the storage unit 330 or the recording medium 340 includes information related to objects which are based on the determined states of the player 2. The video generation unit 304 generates a first video including the objects based on the first video content information. For example, the first video content information may include at least one or the plurality of objects associated with the plurality of players 2 (the objects which are based on the determined states of one or the plurality of players 2 selected based on the selection information). The video generation unit 304 may generate the first video including at least one object among the plurality of objects based on the first video content information.

The first video content information stored in the storage unit 330 or the recording medium 340 may further include information related to the elapsed times in the determined states of the player 2. The video generation unit 304 may generate the first video including the elapsed times based on the first video content information.

In the embodiments, the second video content information stored in the storage unit 330 or the recording medium 340 includes information related to a graph that chronologically shows a change in the exercise situation of the player 2. The video generation unit 304 generates the second video including the graph based on the second video content information. For example, the second video content information may include information related to a graph that chronologically shows a change in the exercise situation of the player 2 selected based on the selection information. The video generation unit 304 may generate the second video including the graph that chronologically shows the change in the exercise situation of the player 2 based on the second video content information.

For example, the video content information stored in the storage unit 330 or the recording medium 340 may include costume information regarding the selected player 2. The video generation unit 304 may generate a video including an image indicating the costume of the selected player 2 based on the video content information.

For example, the video content information stored in the storage unit 330 or the recording medium 340 may include information related to the position of the selected player 2 along the course. The video generation unit 304 may generate a video including the image indicating the position of the selected player 2 along the course based on the video content information.

For example, the video content information stored in the storage unit 330 or the recording medium 340 may include information related to a fatigue (a recovery term) of the selected player 2. The video generation unit 304 may generate a video including an image indicating a fatigue (the recovery term) of the selected player 2 based on the video content information.

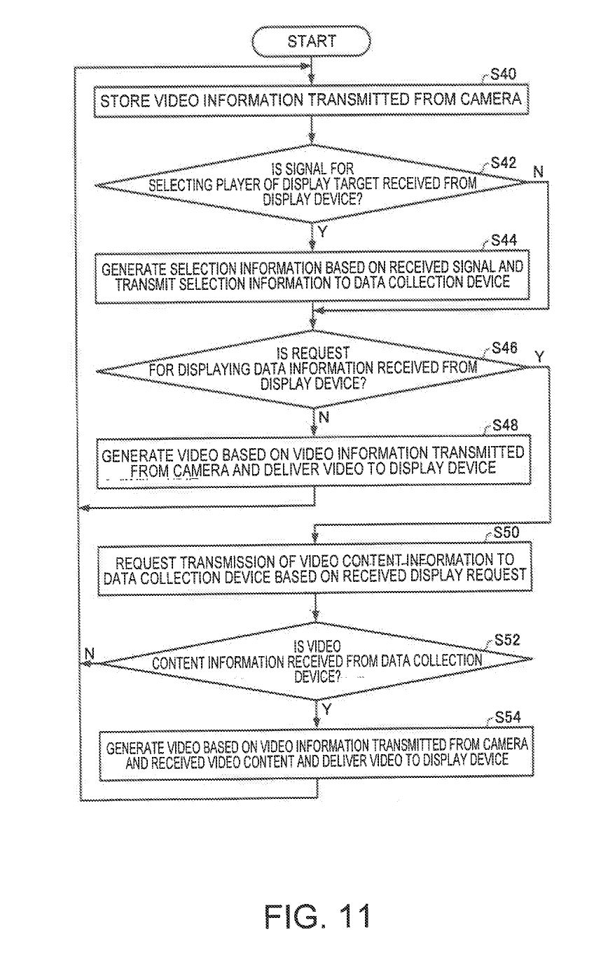

FIG. 11 is a flowchart illustrating an example of a procedure of some processes (video generation process) performed by the processing unit 300 of the video generation device 8. The processing unit 300 of the video generation device 8 performs the video generation process in the procedure of the flowchart in FIG. 11 by executing the video generation program 341 stored in the recording medium 340 or the storage unit 330.

As illustrated in FIG. 11, the processing unit 300 first acquires the video information transmitted from the camera 10 and received by the communication unit 310 and stores the acquired video information in the storage unit 330 or the recording medium 340 (step S40).

Subsequently, when the communication unit 320 receives a signal for selecting the player 2 who is a data information display target from the display device 9 (Y in step S42), the processing unit 300 generates the selection information based on the signal received by the communication unit 320 and transmits the generated selection information to the data collection device 4 via the communication unit 320 (step S44). Conversely, when the communication unit 320 does not receive the signal for selecting the player 2 who is the data information display target from the display device 9 (N in step S42), the processing unit 300 does not perform a process of step S44.

Subsequently, when the communication unit 320 does not receive signal for requesting display of the data information from the display device 9 (N in step S46), the processing unit 300 generates video information based on the video information transmitted from the camera 10 and stored in step S40 and transmits the generated video to the display device 9 via the communication unit 320 (step S48).

Conversely, when the communication unit 320 receives signal for requesting display of the data information from the display device 9 (Y in step S46), the processing unit 300 acquires the display request received by the communication unit 320 and requests the data collection device 4 to transmit the video content information based on the acquired display request (step S50). Then, when the communication unit 320 receives the video content information from the data collection device 4 (Y in step S52), the processing unit 300 acquires the video content information received by the communication unit 320, generates a video based on the video information transmitted from the camera 10 and stored in step S40 and the acquired video content information, and transmits the generated video to the display device 9 via the communication unit 320 (step S54). For example, when there is the request for displaying the first video is made from the display device 9, the processing unit 300 generates the first video including the objects (for example, at least one object among the objects OB1 to OB5 illustrated in FIG. 8) which are based on the determined player 2 state based on the video information transmitted from the camera 10 and the first video content information acquired by requesting the data collection device 4 to transmit the first video content information. When there is a request to display the second video from the display device 9, the processing unit 300 generates the second video including the graph that chronologically shows a change in the exercise situation of the player 2 based on the video information transmitted from the camera 10 and the second video content information acquired by requesting the data collection device 4 to transmit the second video content information.

Conversely, when the communication unit 320 does not receive the video content information from the data collection device 4 (that is, the communication unit 320 waits to receive the video content information) (N in step S52), the processing unit 300 repeatedly performs the processes subsequent to step S40.

Then, the video transmitted to the display device 9 in step S48 or S54 is displayed on the display unit of the display device 9.

### 1-5. Display Example of Video in Display Device

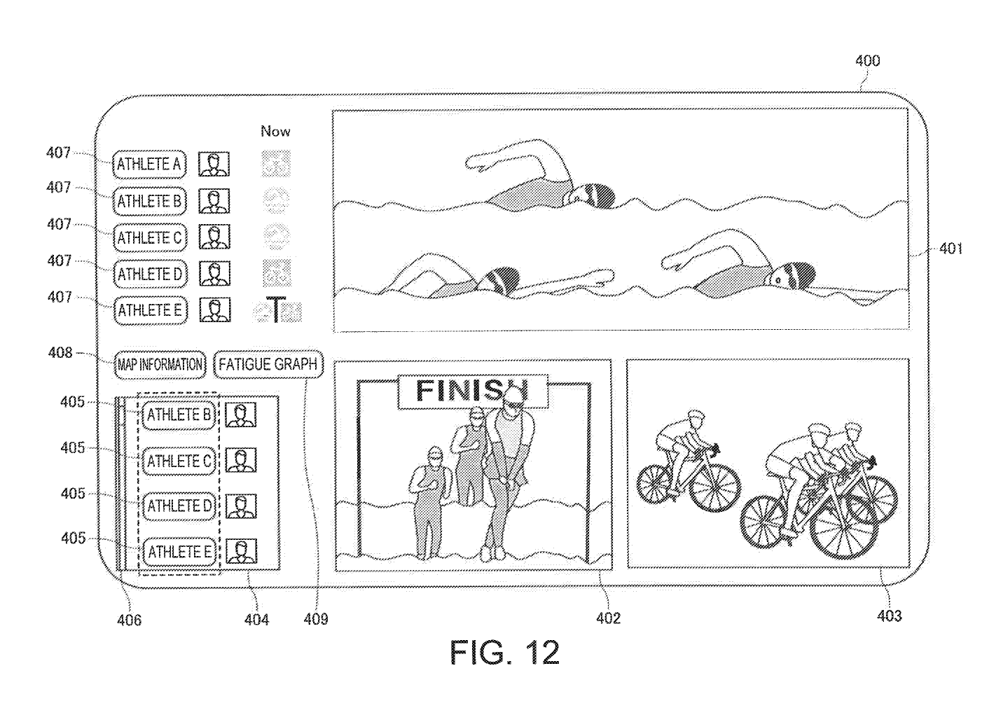

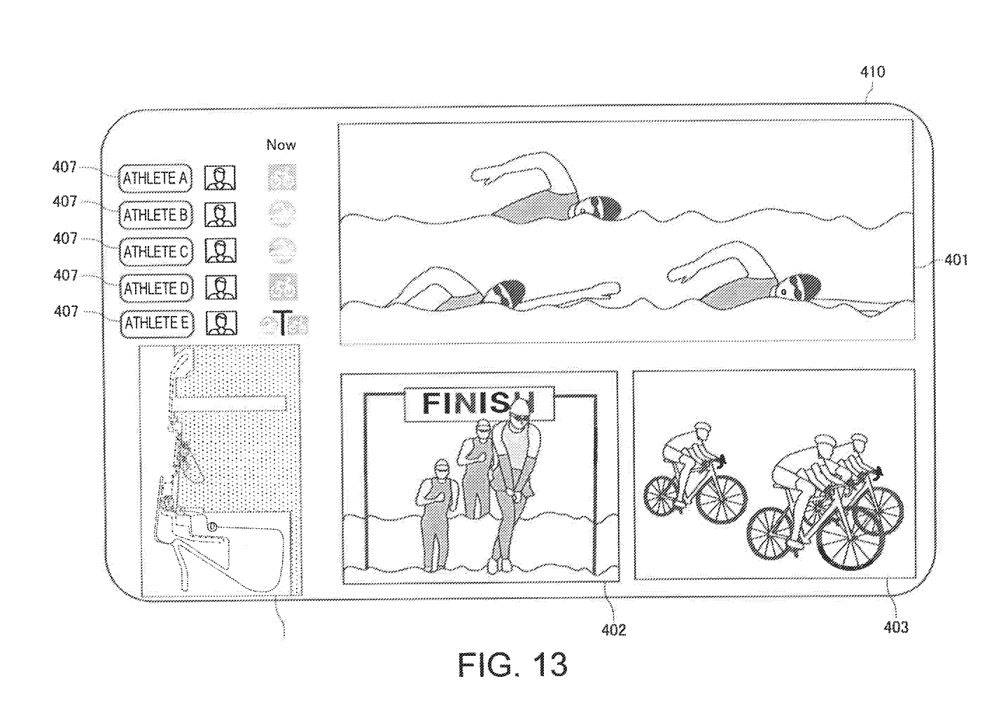

FIGS. 12 to 16 are diagrams illustrating examples of videos displayed on the display unit of the display device 9. A video 400 illustrated in FIG. 12 includes a moving image 401 indicating motions of a plurality of athletes (the players 2) who are swimming, a moving image 402 indicating motions of the plurality of athletes which are transitioning from the swim to the bike (in a transition 1 state), and a moving image 403 indicating motions of a plurality of athletes who are biking. The video 400 includes an athlete selection window 404 that includes a plurality of athlete selection buttons 405 and a scrollbar 406. Thus, a viewer can select an athlete on which the viewer desires to display information by performing an operation of pressing one or the plurality of athlete selection buttons 405. The video 400 includes an athlete identification display button 407 (a button in which an athlete name, number, and the like are displayed) and objects (any of the objects OB1 to OB5 illustrated in FIG. 8) which are based on a face still image and a current state (a determined state) in regard to each of the selected athletes A to E. The video 400 includes a map information button 408 and a fatigue graph button 409. For example, the viewer can enjoy viewing the triathlon recognizing an exercise event of each athlete who the viewer cheers with reference to the video 400.

When the viewer performs an operation of pressing the map information button 408 on the video 400 illustrated in FIG. 12, for example, a video 410 illustrated in FIG. 13 is displayed on the display unit of the display device 9. The video 410 is a video in which the athlete selection window 404, the map information button 408, and the fatigue graph button 409 in the video 400 illustrated in FIG. 12 are replaced with a map information window 411. The map information window 411 includes marks (five circular objects corresponding to the athletes A to E in the example of FIG. 13) indicating the current positions of the athletes along the course of the triathlon. For example, the viewer can enjoy viewing the triathlon recognizing the exercise events or positions of the athletes who the viewer cheers with reference to the video 410.

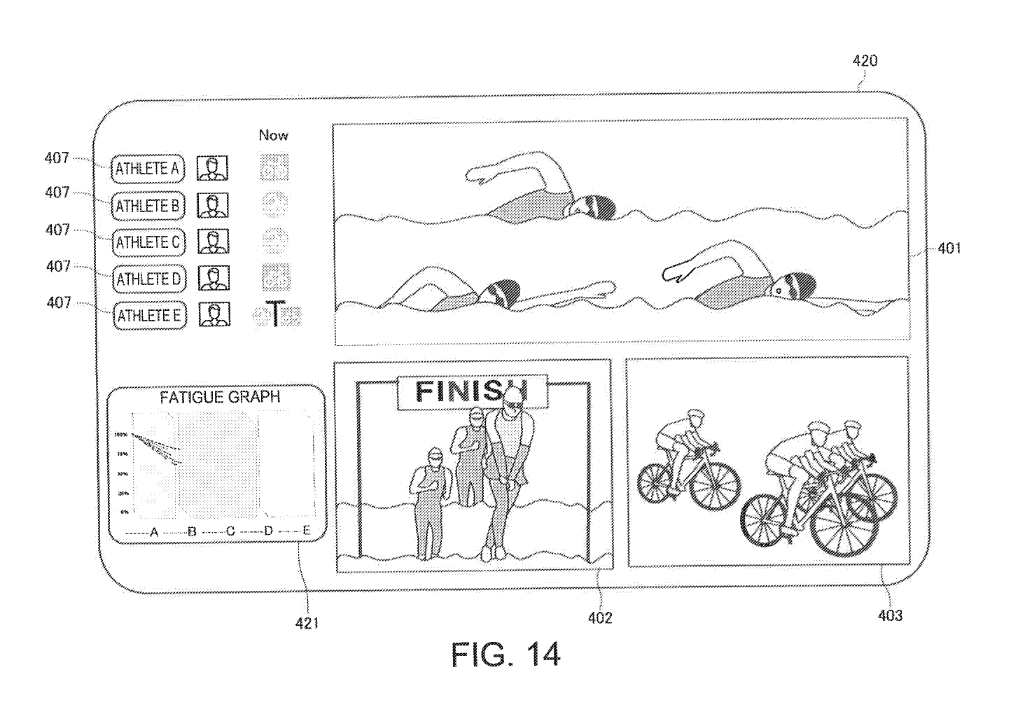

When the viewer performs an operation of pressing the fatigue graph button 409 on the video 400 illustrated in FIG. 12, for example, a video 420 illustrated in FIG. 14 is displayed on the display unit of the display device 9. The video 420 is a video in which the athlete selection window 404, the map information button 408, and the fatigue graph button 409 in the video 400 illustrated in FIG. 12 are replaced with a fatigue graph window 421. The fatigue graph window 421 includes a graph that shows transition (temporal change) of a fatigue (a recovery time) of each athlete. For example, the viewer can enjoy viewing the triathlon recognizing the fatigue of each athlete who the viewer cheers with reference to the video 420.

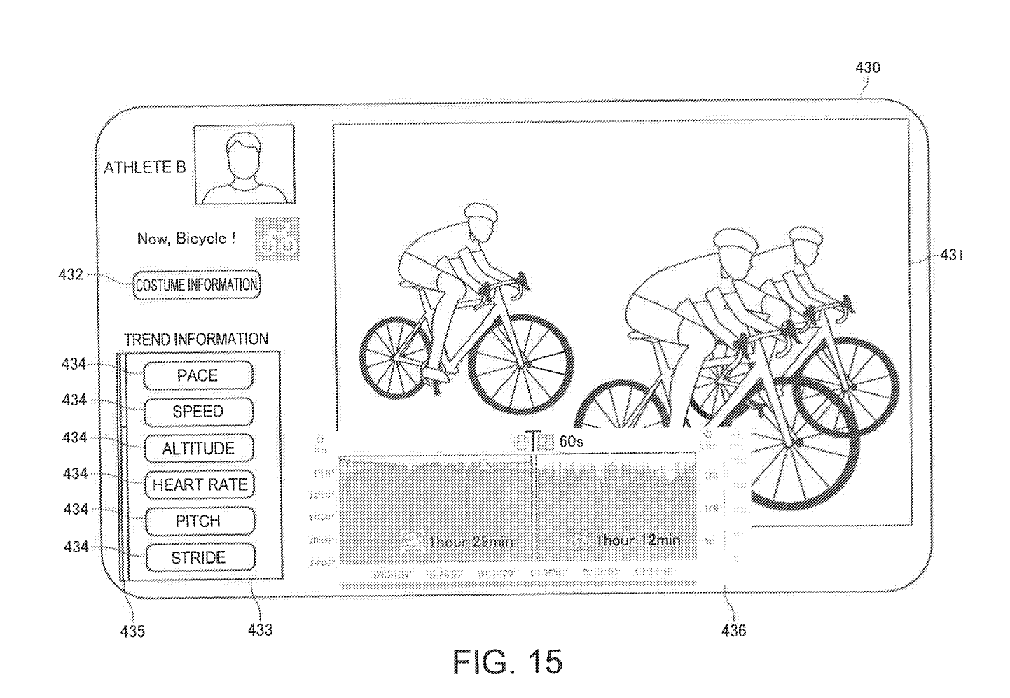

For example, when the viewer performs an operation of pressing the athlete identification display button 407 corresponding to the athlete B on the video 400 illustrated in FIG. 12, for example, a video 430 illustrated in FIG. 15 is displayed on the display unit of the display device 9. The video 430 include a moving image 431 indicating motions of the plurality of athletes (who may include the athlete B) who are biking like the athlete B, an object (the object OB3 illustrated in FIG. 8) which is based on a face image or a current state “bike” of the athlete B, a costume information button 432, a trend information selection window 433, and a trend information display window 436. The trend information selection window 433 includes a plurality of exercise situation selection buttons 434 and a scrollbar 435. Thus, the viewer can select an exercise situation (“pace”, “speed”, “altitude”, “heart rate”, “pitch”, “stride”, or the like) in which the viewer desires to display trend information by performing an operation of pressing one or the plurality of exercise situation selection buttons 434. The trend information display window 436 includes a graph that shows a trend (temporal change) of the selected one or plurality of exercise situations of the athlete B and the objects (the objects OB1, OB2, and OB3 illustrated in FIG. 8) which are based on the states “swim”, “transition 1”, and “bike” of the athlete B. The trend information display window 436 further include information regarding the elapsed times of the states “swim”, “transition 1”, and “bike” of the athlete B. For example, the viewer can enjoy viewing the triathlon recognizing transition of the pace, the heart rate, and the like or the elapsed time of each exercise event of the athlete who the viewer cheers on the video 430.

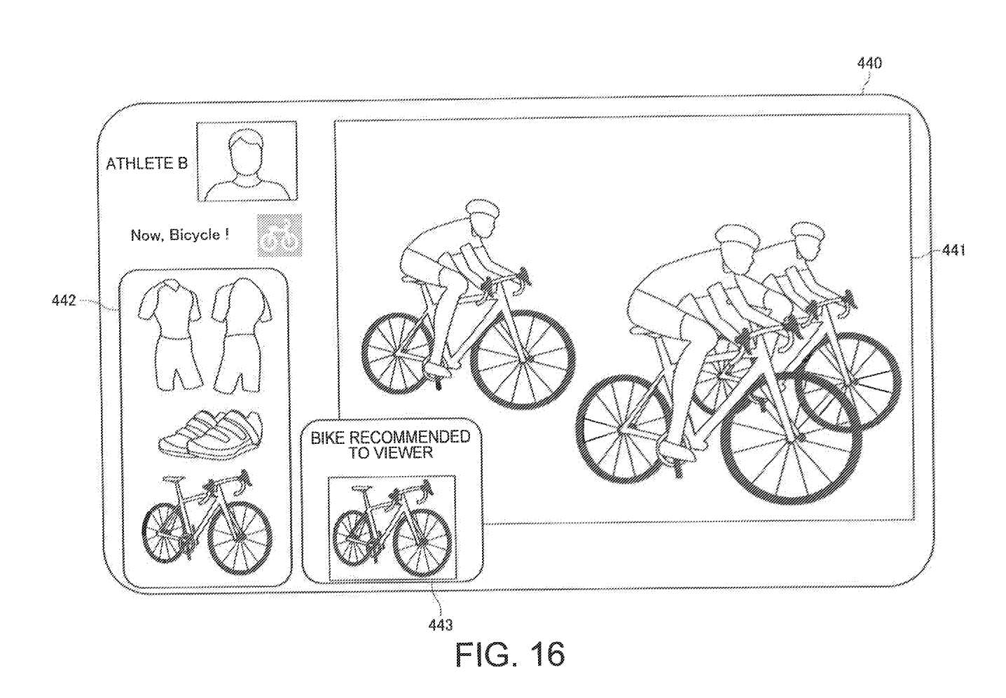

When the viewer performs an operation of pressing the costume information button 432 on the video 420 illustrated in FIG. 14, for example, a video 440 illustrated in FIG. 16 is displayed on the display unit of the display device 9. The video 440 includes a moving image 441 indicating motions of the plurality of athletes (who may include the athlete B) who are biking like the athlete B, an object (the object OB3 illustrated in FIG. 8) which is based on a face image or a current state “bike” of the athlete B, a costume information display window 442, and a recommendation information display window 443. The costume information display window 442 includes an image of a costume (wear, shoes, a bicycle, and the like) used when the athlete B is biking. The recommendation information display window 443 includes an image of a costume recommended to the viewer. For example, the viewer can enjoy viewing the triathlon recognizing the costume or the like used by the athlete who the viewer cheers or the recommended costume or the like on the video 440.

The video 400 illustrated in FIG. 12, the video 410 illustrated in FIG. 13, the video 420 illustrated in FIG. 14, the video 430 illustrated in FIG. 15, and the video 440 illustrated in FIG. 16 are examples of the above-described first video. The video 430 illustrated in FIG. 15 is an example of the above-described second video.

### 1-6. Operational Effect

As described above, in the video delivery system 1 according to the embodiment, each player terminal 3 automatically determines the plurality of states, “swim”, “transition 1”, “bike”, “transition 2”, and “run” of each player 2, generates the exercise information including the determined states, and transmits the exercise information to the data collection device 4. The data collection device 4 receives and stores the exercise information regarding each player 2 transmitted from each player terminal 3, generates the first video content information including the information regarding the objects indicating the determined states in regard to each player 2 selected based on the selection information transmitted from the video generation device 8 in response to the transmission request from the video generation device 8, and transmits the first video content information to the video generation device 8. The video generation device 8 generates the first video including the objects indicating the determined states in regard to each of the selected players 2 based on the first video content information transmitted from the data collection device 4 and delivers the first video to the display device 9. That is, in the video delivery system 1 according to the embodiment, the video including the information related to the game events which each of the selected players 2 is executing or transitioning in the triathlon can be generated and delivered to the display device 9.

In the video delivery system 1 according to the embodiment, the data collection device 4 generates the first video content information including the information regarding the objects indicating the determined states and the information regarding the elapsed times in the states in regard to each of the selected players 2 in response to the transmission request from the video generation device 8 and transmits the first video content information to the video generation device 8. The video generation device 8 generates the first video including the objects indicating the determined states and the information regarding the elapsed times in the states in regard to each of the selected players 2 based on the first video content information transmitted from the data collection device 4 and delivers the first video to the display device 9. That is, in the video delivery system 1 according to the embodiment, the video including the information related to the game events which each of the selected players 2 is executing or transitioning in the triathlon and the information related to the execution times or the transition times of the game events can be generated and delivered to the display device 9.

In the video delivery system 1 according to the embodiment, the data collection device 4 generates the second video content information including the information related to the graph that chronologically shows the change in the exercise situation of each of the selected players 2 in response to the transmission request from the video generation device 8 and transmits the second video content information to the video generation device 8. The video generation device 8 generates the second video including the graph that chronologically shows the change in the exercise situation in regard to each of the selected players 2 based on the second video content information transmitted from the data collection device 4 and delivers the second video to the display device 9. That is, in the video delivery system 1 according to the embodiment, the video including the information regarding the trend of the exercise situation of each of the selected players 2 in the triathlon can be generated and delivered to the display device 9.

Further, in the video delivery system 1 according to the embodiment, each of the plurality of player terminals 3 automatically determines the states of each player 2. Therefore, when the game event switches from the swim to the bike or switches from the bike to the run, manual work is not necessary, and thus each player 2 can focus on the triathlon.

### 2. Modification Examples

The invention is not limited to the embodiment, but various modifications can be made within a range of the gist of the invention. Hereinafter, modification examples will be described. The same reference numerals are given to the same configurations as those of the foregoing embodiment and the description thereof will be omitted.

For example, in the foregoing embodiment, the video generation device 8 may generate the video for live broadcast and delivers the video to the display device 9, but may generate a video for pre-recorded broadcast and deliver the video to the display device 9. When the video generation device 8 generates the video for pre-recorded broadcast and does not generate the video for live broadcast, the processing unit 100 of the player terminal 3 receives a signal indicating a measurement end operation (that is, the player 2 ends the triathlon), and then transmit exercise information regarding the player 2 stored in the storage unit 140 to the data collection device 4 spontaneously or in response to a request from the data collection device 4.

For example, the video generation device 8 acquires weather information such as weather, wind speed, or wave heights of the present, the past, and the future from the data collection device 4, the player terminal 3, or a weather information server or the like (not illustrated), generates a video including the weather information, and deliver the video to the display device 9.

For example, the processing unit 100 of the player terminal 3 may perform a player 2 state determination process in a different procedure from the procedure of the state determination process (the swim determination process (step S100), the transition 1 determination process (step S200), the bike determination process (S300), the transition 2 determination process (step S400), and the run determination process (step S500)) illustrated in FIG. 6.

In a first modification example of the player 2 state determination process, the processing unit 100 of the player terminal 3 performs a process of determining the plurality of states of the player 2, “swim”, “transition 1”, “bike”, “transition 2”, and “run” based on positioning data (positional information) generated and output by the GPS sensor 110, a signal output by the acceleration sensor 113 and a signal output by the pressure sensor 112.

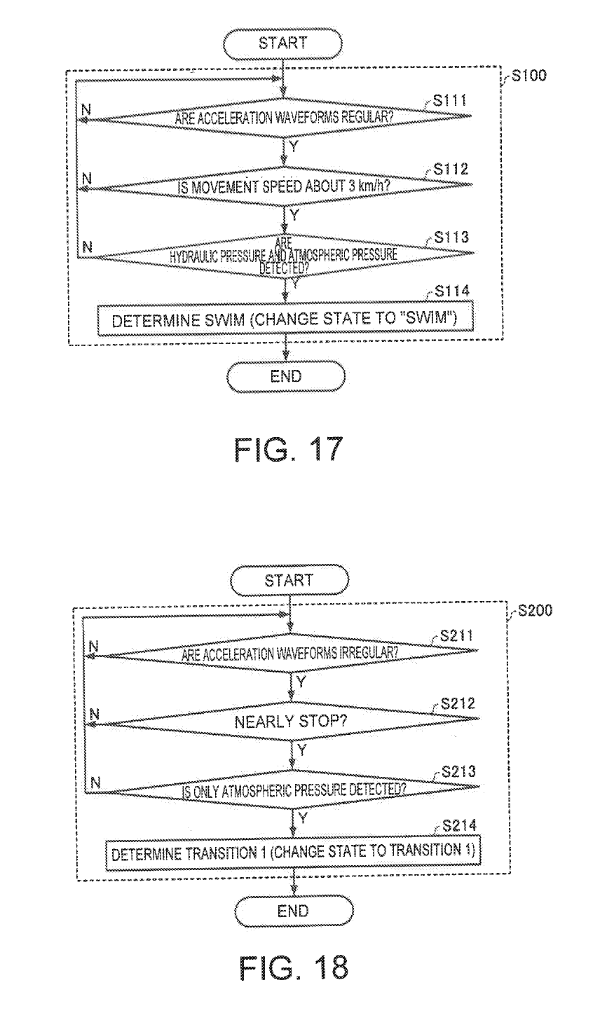

As illustrated in FIG. 17, when the acceleration waveforms (the waveforms output by the acceleration sensor 113) are regular (have regularity) (Y in step S111), the movement speed obtained by differentiating the position of the player terminal 3 included in the positioning data of the GPS sensor 110 is about 3 km/h (Y in step S112), and the hydraulic pressure and the atmospheric pressure are detected based on the signals output by the pressure sensor 112 (Y in step S113) in the swim determination process (step S100) as in the embodiment, the processing unit 100 determines that the player 2 is swimming and changes the player 2 state from the indeterminate state to “swim” (step S114).

In the transition 1, since the player 2 changes clothes or the like, the motions of the arms of the player 2 are irregular (have no regularity) and signals output by the acceleration sensor 113 are irregular (have no regularity). The position of the player 2 is not substantially changed and the player nearly stops (the movement speed is zero). Further, since the arms of the player 2 are normally in the air, the pressure sensor 112 detects only the atmospheric pressure. Accordingly, as illustrated in FIG. 18, when the acceleration waveforms (the waveforms output by the acceleration sensor 113) are irregular (have no regularity) (Y in step S211), the movement speed of the player terminal 3 is nearly zero (the player nearly stops) (Y in step S212), and only the atmospheric pressure is detected based on the signal output by the pressure sensor 112 (no hydraulic pressure is detected) (Y in step S213) in the transition 1 determination process (step S200), the processing unit 100 determines that the player 2 is in the transition 1 state and changes the player 2 state from “swim” to “transition 1” (step S214). The processing unit 100 may determine that the acceleration waveforms are irregular when a period at which a voltage of a signal output by the acceleration sensor 113 matches the threshold Vt2 is not substantially constant (within a predetermined range) for a predetermined time or a state in which the voltage is less than the threshold Vt2 continues for the predetermined time. The threshold Vt2 may be appropriately determined. The processing unit 100 may determine that only the atmospheric pressure is detected when a pressure applied to the player terminal 3 and calculated using a signal output by the pressure sensor 112 is less than the threshold Pt2 for the predetermined time. The threshold Pt2 may be appropriately determined.

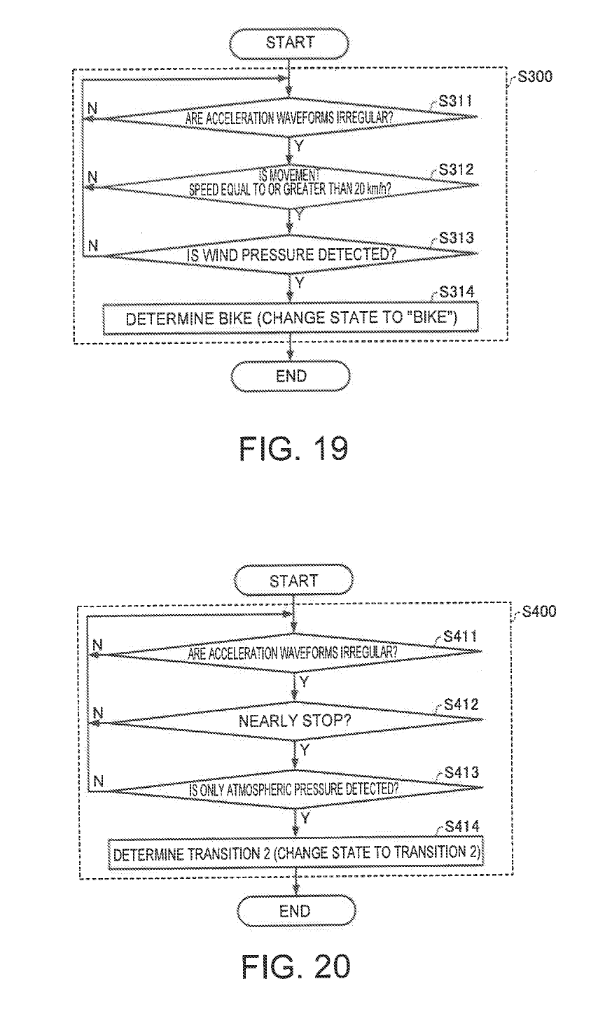

In the bike, since the motions of the arms of the player 2 are irregular (have no regularity), the waveforms of the signals output by the acceleration sensor 113 are irregular (have no regularity). A speed (movement speed) at which the player 2 is biking is equal to or greater than a predetermined speed (for example, 20 km/h). Since the player 2 moves against wind, the pressure sensor 112 detects a wind pressure. Accordingly, as illustrated in FIG. 19, when the acceleration waveforms (the waveforms output by the acceleration sensor 113) are irregular (have no periodicity) (Y in step S311), the movement speed of the player terminal 3 is equal to or greater than 20 km/h (Y in step S312), and a wind pressure is detected based on a signal output by the pressure sensor 112 (Y in step S313) in the bike determination process (step S300), the processing unit 100 determines that the player 2 is biking and changes the player 2 state from “transition 1” to “bike” (step S314).

In the transition 2, since the player 2 is changing clothes or the like, the motions of the arms of the player 2 are irregular (have no regularity) and the waveforms of the signals output by the acceleration sensor 113 are irregular (have no regularity). The position of the player 2 is not substantially changed and the player 2 nearly stops (a movement speed is zero). Further, since the arms of the player 2 are in the air, the pressure sensor 112 detects only the atmospheric pressure. Accordingly, as illustrated in FIG. 20, when the acceleration waveforms (the waveforms output by the acceleration sensor 113) are irregular (have no regularity) (Y in step S411), the movement speed of the player terminal 3 is nearly zero (the player nearly stops) (Y in step S412), and only the atmospheric pressure is detected based on the signal output by the pressure sensor 112 (no hydraulic pressure is detected) (Y in step S413) in the transition 2 determination process (step S400), the processing unit 100 determines that the player 2 is in the transition 2 state and changes the player 2 state from “bike” to “transition 2” (step S414).

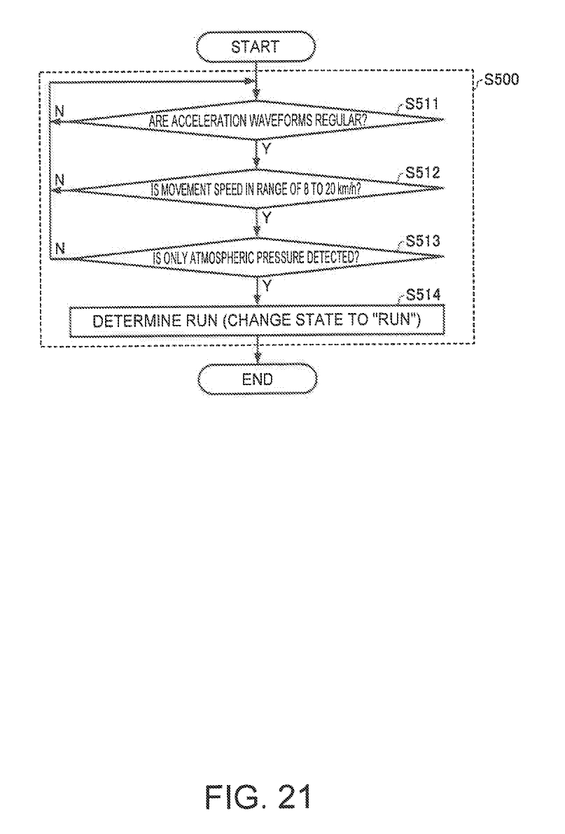

In the run, since the arm swinging of the player 2 is regular (has regularity), the waveforms of the signals output by the acceleration sensor 113 are regular (have regularity). A speed (movement speed) at which the player 2 is running is within a predetermined speed range (for example, 8 km/h to 20 km/h). Further, since the arms of the player 2 are normally in the air, the pressure sensor 112 detects only the atmospheric pressure. Accordingly, as illustrated in FIG. 21, when the acceleration waves (the waveforms output by the acceleration sensor 113) are regular (have regularity) (Y in step S511), the movement speed of the player terminal 3 is within the range of 8 km/h to 20 km/h (Y in step S512), and only the atmospheric pressure is detected based on the signal output by the pressure sensor 112 (no hydraulic pressure is detected) (Y in step S513) in the run determination process (step S500), the processing unit 100 determines that the player 2 is running and changes the player 2 state from “transition 2” to “run” (step S514).

In a second modification example of the player 2 state determination process, the processing unit 100 of the player terminal 3 performs a process of determining the plurality of states of the player 2, “swim”, “transition 1”, “bike”, “transition 2”, and “run” based on the positioning data (positional information) generated and output by the GPS sensor 110, at least one of the signal output by the acceleration sensor 113 and the signal output by the pressure sensor 112, and at least one of the signal output by the angular velocity sensor 114 and the signal output by the temperature sensor 116.

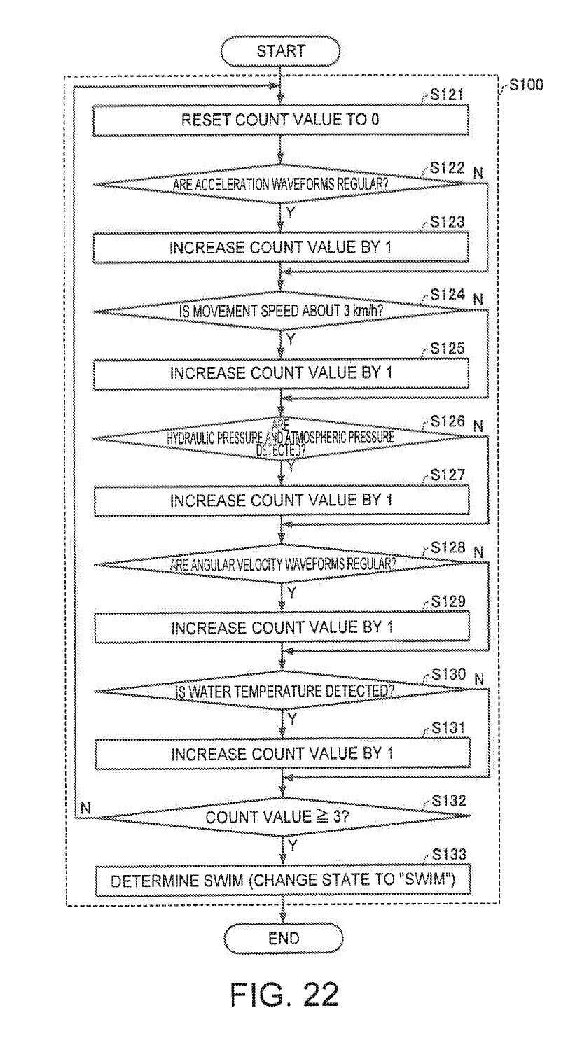

In the swim, the strokes of the arms of the player 2 are regular (have regularity), a speed at which the player 2 is swimming is within a predetermined speed range (for example, about 3 km/h), and a state in which the arms of the player 2 are in the air and a state in which the arms are in the water are alternately repeated. Accordingly, as illustrated in FIG. 22, the processing unit 100 first resets a count value of a counter (not illustrated) to 0 in the swim determination process (step S100) (step S121). Subsequently, when the acceleration waveforms (the waveforms output by the acceleration sensor 113) are regular (have regularity) (Y in S122), the processing unit 100 increases the count value by 1 (step S123). Then, when the movement speed obtained by differentiating the position of the player terminal 3 included in positioning data measured by the GPS sensor 110 is about 3 km/h (Y in step S124), the processing unit 100 increases the count value by 1 (step S125). When the hydraulic pressure and the atmospheric pressure are detected based on a signal output by the pressure sensor 112 (Y in step S126), the processing unit 100 increases the count value by 1 (step S127). When angular velocity waveforms (waveforms output by the angular velocity sensor 114) are regular (have periodicity) (Y in step S128), the processing unit 100 increases the count value by 1 (step S129). When a period at which a voltage of a signal output by the angular velocity sensor 114 matches a threshold Vt3 is substantially constant (within a predetermined range) for a predetermined time, the processing unit 100 may determine that the angular velocity waveforms are regular. The threshold Vt3 may be appropriately determined. When a water temperature is detected based on a signal output by the temperature sensor 116 (Y in step S130), the processing unit 100 increases the count value by 1 (step S131). Then, when the count value is less than 3 (N in step S132), the processing unit 100 performs the process subsequent to step S121 again. When the count value is equal to or greater than 3 (Y in step S132), the processing unit 100 determines that the player 2 is swimming and changes the player 2 state from an indeterminate state to “swim” (step S133). In the flowchart of FIG. 22, the determination sequence of steps S122, S124, S126, S128, and S130 may be appropriately changed.

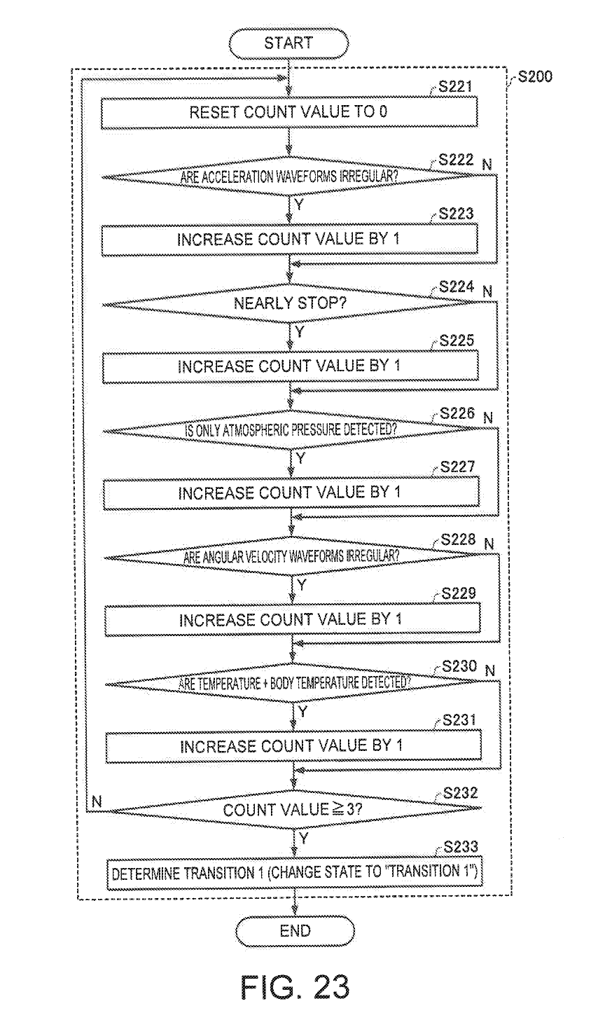

In the transition 1, since the player 2 is changing clothes or the like, the motions of the arms of the player 2 are irregular (have no regularity), the position of the player 2 is not substantially changed, and the arms of the player 2 are normally in the air. Accordingly, as illustrated in FIG. 23, the processing unit 100 first resets the count value of the counter (not illustrated) to 0 in the transition 1 determination process (step S200) (step S221). Subsequently, when the acceleration waveforms (the waveforms output by the acceleration sensor 113) are irregular (have regularity) (Y in S222), the processing unit 100 increases the count value by 1 (step S223). Then, when the movement speed of the player terminal 3 is nearly zero (the player nearly stops) (Y in step S224), the processing unit 100 increases the count value by 1 (step S225). When only the atmospheric pressure is detected based on a signal output by the pressure sensor 112 (no hydraulic pressure is detected) (Y in step S226), the processing unit 100 increases the count value by 1 (step S227). When angular velocity waveforms (waveforms output by the angular velocity sensor 114) are irregular (have no periodicity) (Y in step S228), the processing unit 100 increases the count value by 1 (step S229). When a period at which a voltage of a signal output by the angular velocity sensor 114 matches a threshold Vt4 is not substantially constant (within a predetermined range) for a predetermined time or a state in which the voltage is less than the threshold Vt4 continuous for a predetermined time, the processing unit 100 may determine that the angular velocity waveforms are irregular. The threshold Vt4 may be appropriately determined. When a temperature and a body temperature of the player 2 are detected based on signals output by the temperature sensor 116 (Y in step S230), the processing unit 100 increases the count value by 1 (step S231). Then, when the count value is less than 3 (N in step S232), the processing unit 100 performs the process subsequent to step S221 again. When the count value is equal to or greater than 3 (Y in step S232), the processing unit 100 determines that the player 2 is in the transition 1 state and changes the player 2 state from “swim” to “transition 1” (step S233). In the flowchart of FIG. 23, the determination sequence of steps S222, S224, S226, S228, and S230 may be appropriately changed.

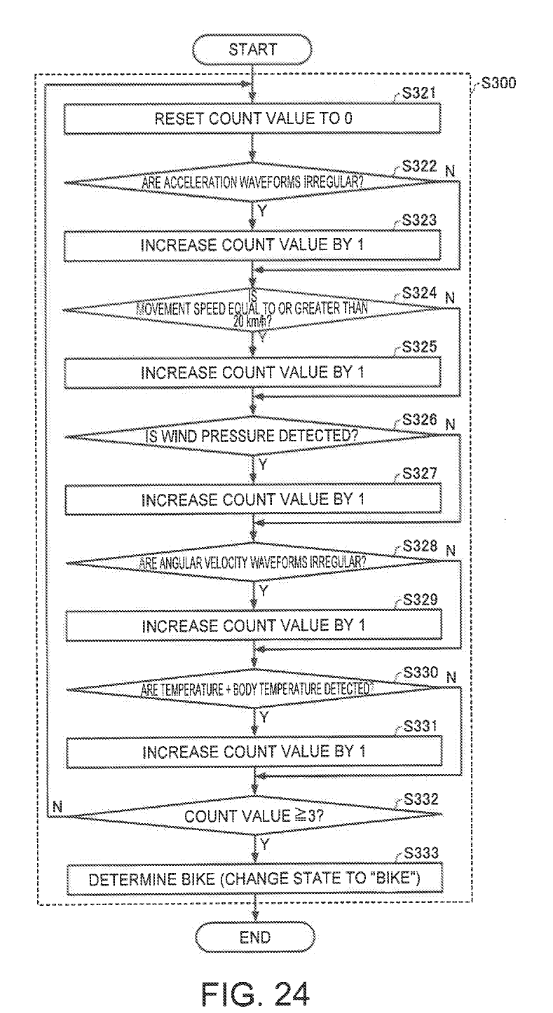

In the bike, the motions of the arms of the player 2 are irregular (have no periodicity), a speed at which the player 2 is biking is equal to or greater than a predetermined speed (for example, 20 km/h), the player 2 moves against wind, and the arms of the player 2 are normally in the air. Accordingly, as illustrated in FIG. 24, the processing unit 100 first resets the count value of the counter (not illustrated) to 0 in the bike determination process (step S300) (step S321). Subsequently, when the acceleration waveforms (the waveforms output by the acceleration sensor 113) are irregular (have no regularity) (Y in S322), the processing unit 100 increases the count value by 1 (step S323). Then, when the movement speed of the player terminal 3 is equal to or greater than 20 km/h (Y in step S324), the processing unit 100 increases the count value by 1 (step S325). When the wind pressure is detected based on a signal output by the pressure sensor 112 (Y in step S326), the processing unit 100 increases the count value by 1 (step S327). When angular velocity waveforms (waveforms output by the angular velocity sensor 114) are irregular (have no periodicity) (Y in step S328), the processing unit 100 increases the count value by 1 (step S329). When a temperature and a body temperature of the player 2 are detected based on signals output by the temperature sensor 116 (Y in step S330), the processing unit 100 increases the count value by 1 (step S331). Then, when the count value is less than 3 (N in step S332), the processing unit 100 performs the process subsequent to step S321 again. When the count value is equal to or greater than 3 (Y in step S332), the processing unit 100 determines that the player 2 is biking and changes the player 2 state from “transition 1” to “bike” (step S333). In the flowchart of FIG. 24, the determination sequence of steps S322, S324, S326, S328, and S330 may be appropriately changed.

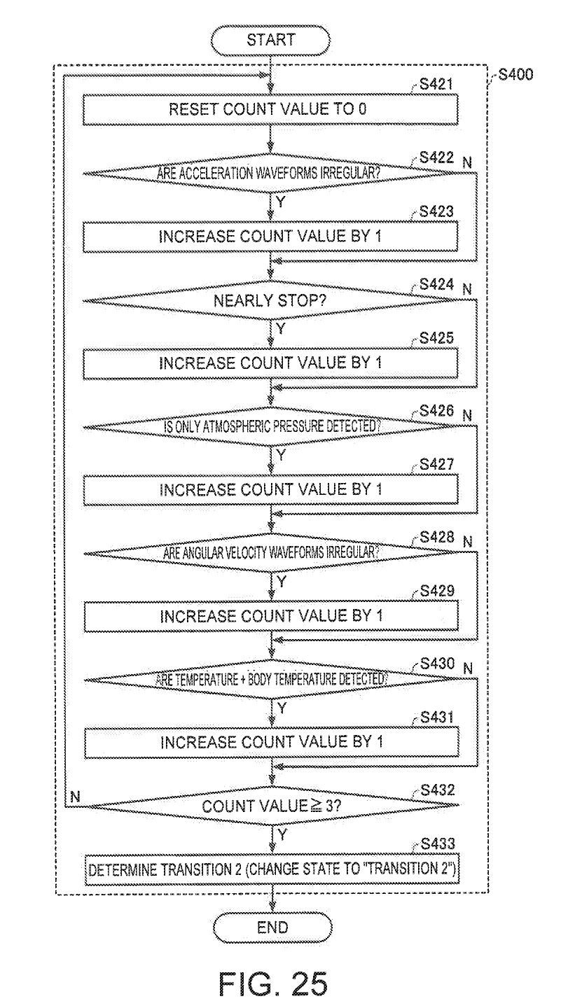

In the transition 2, since the player 2 is changing clothes or the like, the motions of the arms of the player 2 are irregular (have no regularity), the position of the player 2 is not substantially changed, and the arms of the player 2 are normally in the air. Accordingly, as illustrated in FIG. 25, the processing unit 100 first resets the count value of the counter (not illustrated) to 0 in the transition 2 determination process (step S400) (step S421). Subsequently, when the acceleration waveforms (the waveforms output by the acceleration sensor 113) are irregular (have no regularity) (Y in S422), the processing unit 100 increases the count value by 1 (step S423). Then, when the movement speed of the player terminal 3 is nearly zero (the player nearly stops) (Y in step S424), the processing unit 100 increases the count value by 1 (step S425). When only the atmospheric pressure is detected based on a signal output by the pressure sensor 112 (no hydraulic pressure is detected) (Y in step S426), the processing unit 100 increases the count value by 1 (step S427). When angular velocity waveforms (waveforms output by the angular velocity sensor 114) are irregular (have no periodicity) (Y in step S428), the processing unit 100 increases the count value by 1 (step S429). When a temperature and a body temperature of the player 2 are detected based on signals output by the temperature sensor 116 (Y in step S430), the processing unit 100 increases the count value by 1 (step S431). Then, when the count value is less than 3 (N in step S432), the processing unit 100 performs the process subsequent to step S421 again. When the count value is equal to or greater than 3 (Y in step S432), the processing unit 100 determines that the player 2 is in the transition 2 state and changes the player 2 state from “bike” to “transition 2” (step S433). In the flowchart of FIG. 25, the determination sequence of steps S422, S424, S426, S428, and S430 may be appropriately changed.

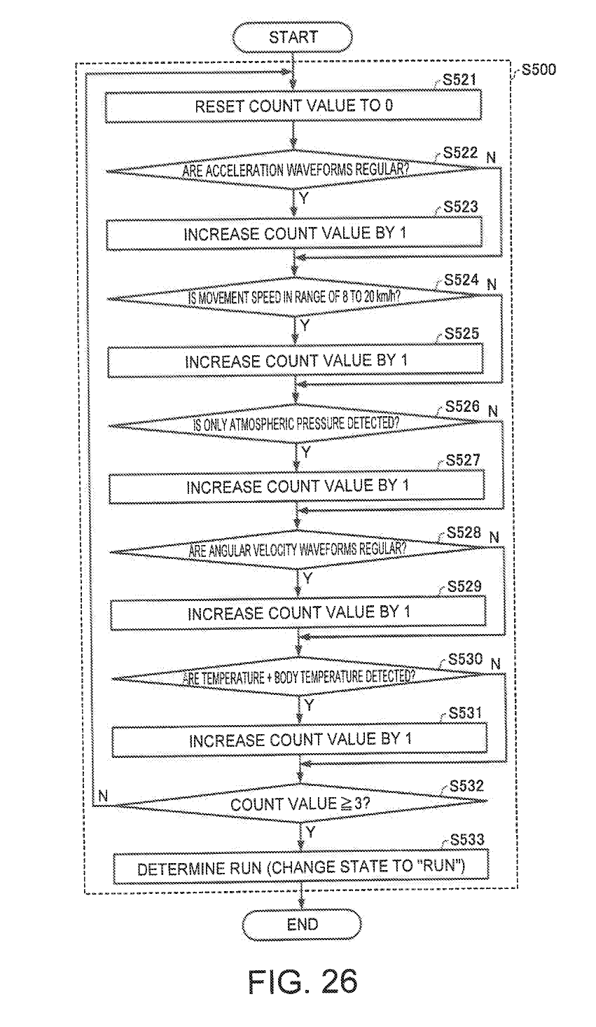

In the run, the arm swinging of the player 2 is regular (has regularity), a speed at which the player 2 is swimming is within a predetermined speed range (for example, about 8 km/h to 20 km/h), and the arms of the player 2 are normally in the air. Accordingly, as illustrated in FIG. 26, the processing unit 100 first resets a count value of the counter (not illustrated) to 0 in the run determination process (step S500) (step S521). Subsequently, when the acceleration waveforms (the waveforms output by the acceleration sensor 113) are regular (have regularity) (Y in S522), the processing unit 100 increases the count value by 1 (step S523). Then, when the movement speed of the player terminal 3 is within the range of 8 km/h to 20 km/h (Y in step S524), the processing unit 100 increases the count value by 1 (step S525). When only the atmospheric pressure is detected based on a signal output by the pressure sensor 112 (no hydraulic pressure is detected) (Y in step S526), the processing unit 100 increases the count value by 1 (step S527). When angular velocity waveforms (waveforms output by the angular velocity sensor 114) are regular (have periodicity) (Y in step S528), the processing unit 100 increases the count value by 1 (step S529). When a temperature and a body temperature of the player 2 are detected based on signals output by the temperature sensor 116 (Y in step S530), the processing unit 100 increases the count value by 1 (step S531). Then, when the count value is less than 3 (N in step S532), the processing unit 100 performs the process subsequent to step S521 again. When the count value is equal to or greater than 3 (Y in step S532), the processing unit 100 determines that the player 2 is running and changes the player 2 state from “transition 2” to “run” (step S533). In the flowchart of FIG. 26, the determination sequence of steps S522, S524, S526, S528, and S530 may be appropriately changed.

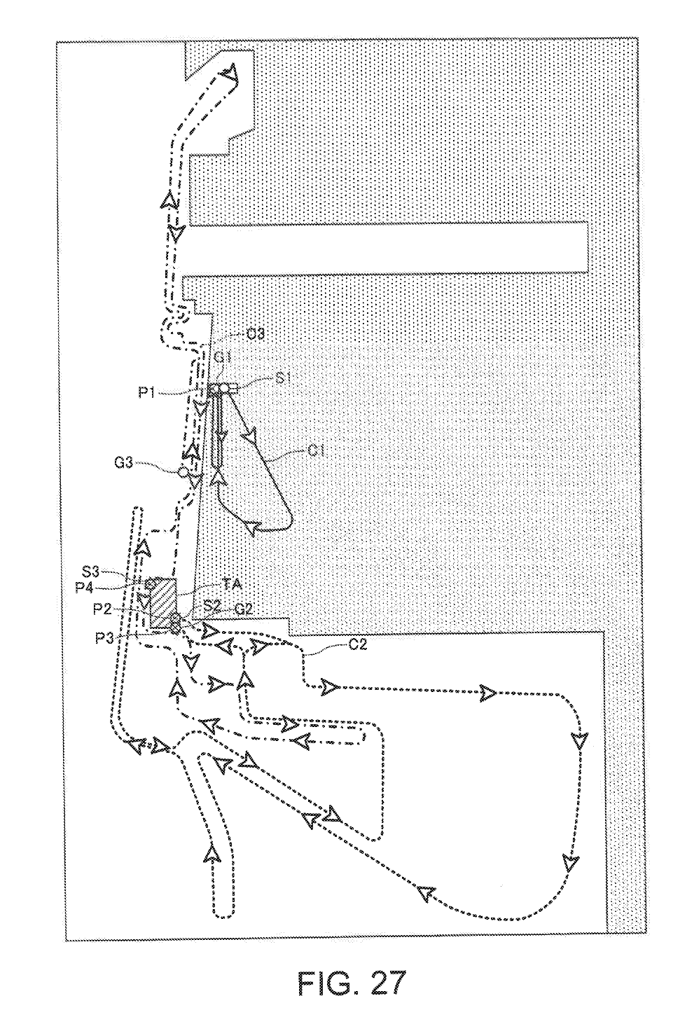

In a third modification example of the player 2 state determination process, as illustrated in FIG. 27, before the player 2 starts the triathlon, the player 2 registers the goal point G1 of the swim or a position P1 (first position) near the goal point G1, the start point S2 of the bike or a position P2 (second position) near the start point S2, the goal point G2 of the bike or a position P3 (third position) near the goal point G2, and the start point S3 of the run or a point P4 (fourth position) near the start point S3 in the storage unit 140 of the player terminal 3 in advance. The player 2 may actually go to the goal point G1 of the swim, the start point S2 of the bike, the goal point G2 of the bike, and the start point S3 of the run and operates the operation unit 120 of the player terminal 3 to register the positions (latitude and longitude) of the current locations as the positions P1, P2, P3, and P4 in the storage unit 140. Alternatively, the player 2 may select positions corresponding to the goal point G1 of the swim, the start point S2 of the bike, the goal point G2 of the bike, and the start point S3 of the run on map data of an area of the triathlon with the information terminal 5 and the player terminal 3 may receive information regarding the selected positions (latitude and longitude) via the communication unit 170 to register the selected positions as the positions P1, P2, P3, and P4 in the storage unit 140. Then, the processing unit 100 of the player terminal 3 determines five states of the player 2, “swim”, “transition 1”, “bike”, “transition 2”, and “run” based on the positional information obtained based on satellite signals transmitted from the GPS satellite 7 and the positions P1, P2, P3, and P4 registered in advance.

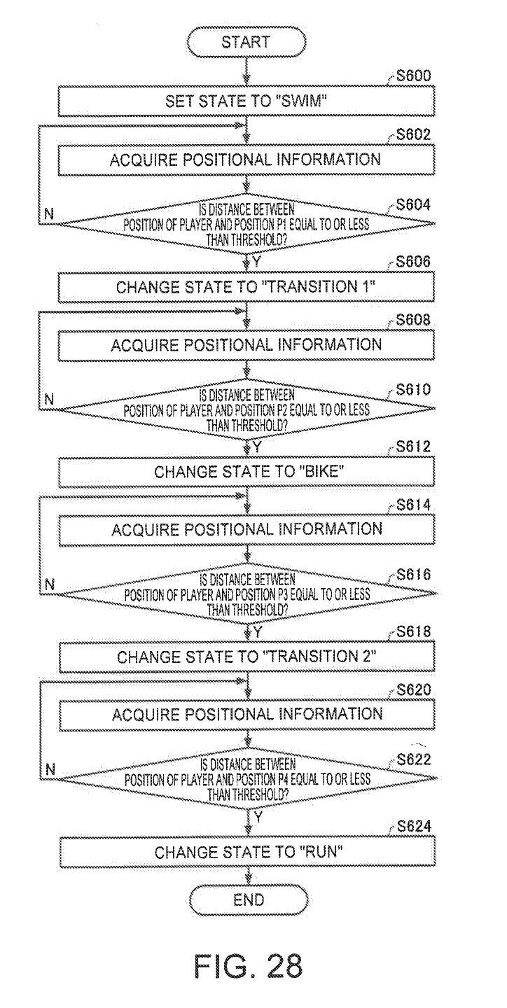

FIG. 28 is a flowchart illustrating a detailed example of a state determination process according to the third modification example. As illustrated in FIG. 28, the processing unit 100 first sets the player 2 state to “swim” (step S600). Subsequently, the processing unit 100 acquires positioning data (positional information) from the GPS sensor 110 (step S602) and determines whether a distance between the position of the player 2 and the position P1 is equal to or less than a threshold based on the acquired positional information and the registered position P1 (step S604). The threshold may be appropriately determined. When the distance between the position of the player 2 and the position P1 is not equal to or less than the threshold (N in step S604), the processing unit 100 performs the processes of steps S602 and S604 again. Conversely, when the distance between the position of the player 2 and the position P1 is equal to or less than the threshold (Y in step S604), the processing unit 100 changes the player 2 state from “swim” to “transition 1” (step S606). Subsequently, the processing unit 100 acquires positioning data (positional information) from the GPS sensor 110 (step S608) and determines whether a distance between the position of the player 2 and the position P2 is equal to or less than the threshold based on the acquired positional information and the registered position P2 (step S610). When the distance between the position of the player 2 and the position P2 is not equal to or less than the threshold (N in step S610), the processing unit 100 performs the processes of steps S608 and S610 again. Conversely, when the distance between the position of the player 2 and the position P2 is equal to or less than the threshold (Y in step S610), the processing unit 100 changes the player 2 state from “transition 1” to “bike” (step S612). Subsequently, the processing unit 100 acquires positioning data (positional information) from the GPS sensor 110 (step S614) and determines whether a distance between the position of the player 2 and the position P3 is equal to or less than the threshold based on the acquired positional information and the registered position P3 (step S616). When the distance between the position of the player 2 and the position P3 is not equal to or less than the threshold (N in step S616), the processing unit 100 performs the processes of steps S614 and S616 again. Conversely, when the distance between the position of the player 2 and the position P3 is equal to or less than the threshold (Y in step S616), the processing unit 100 changes the player 2 state from “bike” to “transition 2” (step S618). Subsequently, the processing unit 100 acquires positioning data (positional information) from the GPS sensor 110 (step S620) and determines whether a distance between the position of the player 2 and the position P4 is equal to or less than the threshold based on the acquired positional information and the registered position P4 (step S622). When the distance between the position of the player 2 and the position P4 is not equal to or less than the threshold (N in step S622), the processing unit 100 performs the processes of steps S620 and S622 again. Conversely, when the distance between the position of the player 2 and the position P4 is equal to or less than the threshold (Y in step S622), the processing unit 100 changes the player 2 state from “transition 2” to “run” (step S624).

For example, the video delivery system 1 according to the foregoing embodiment delivers the video of the triathlon. However, the video delivery system 1 may also deliver a video of any game including a plurality of game events such as winter triathlon (snow run=>snow bike=>cross country ski), duathlon (first run=>bike=>second run), or aquathlon (run=>swim or first run=>swim=>second run), biathlon (cross country ski=>rifle shooting). For example, in a winter triathlon, the processing unit 100 of the player terminal 3 can apply the above-described run determination process to determination of whether the player 2 is executing a snow run. The above-described bike determination process can be applied to determination of whether the player 2 is executing a snow bike. The above-described transition 1 determination process can be applied to transition of the player 2 from the snow run to the snow bike and the above-described transition 2 determination process can be applied to transition of the player 2 from the snow bike to a cross country. In general, in cross country ski, the player 2 pokes the ground with a stock in an uphill ground or a flat ground. Therefore, a waveform of a signal output by the acceleration sensor 113 or a signal output by the angular velocity sensor 114 has a steep peak. Since a traveling speed (movement speed) of the player 2 is within a predetermined speed range (for example, 20 km/h or less) and the arms of the player 2 are normally in the air, the temperature sensor 116 detects temperature. In a downhill ground, a traveling speed (movement speed) of the player 2 is high (for example, 20 km/h or more) and an altitude continuously decreases. Therefore, coordinates indicating an altitude of positioning data (positioning information) generated and output by the GPS sensor 110 or atmospheric pressure detected by the pressure sensor 112 continuously decreases and the arms of the player 2 are normally in the air, the temperature sensor 116 detects temperature. Accordingly, the processing unit 100 of the player terminal 3 can determine that the player 2 is executing cross country ski based on at least one of signals output by the GPS sensor 110, the pressure sensor 112, the acceleration sensor 113, the angular velocity sensor 114, and the temperature sensor 116.

For example, in the foregoing embodiment, at least some of the various sensors (the GPS sensor 110, the geomagnetic sensor 111, the pressure sensor 112, the acceleration sensor 113, the angular velocity sensor 114, the pulse rate sensor 115, and the temperature sensor 116) may not be integrated with the player terminal 3.

For example, in the foregoing embodiment, some of the functions of the data collection device 4 or the information terminal 5 may be mounted on the player terminal 3 and some of the functions of the player terminal 3 may be mounted on the data collection device 4 or the information terminal 5. For example, some of the functions of the data collection device 4 may be mounted on the video generation device 8 or some of the functions of the video generation device 8 may be mounted on the data collection device 4.

For example, in the foregoing embodiment, functions of a known smartphone, for example, a camera function, a calling function, and a communication function may be mounted on the player terminal 3 or another sensing function (a humidity sensor or the like) may be mounted on the player terminal 3. For example, the player terminal 3 can be configured not only with a wrist type electronic device but also with any of various types of electronic devices such as an earphone type electronic device, a ring type electronic device, a pendant type electronic device, an electronic device worn on a sports instrument, a smartphone, and a head-mounted display (HMD). The player terminal 3 may be mounted at a position at which an exercise situation of the player 2 can be analyzed or may be mounted not only on a wrist but also, for example, an arm, a waist, a breast, or a leg.

For example, in the foregoing embodiment, the player terminal 3 performs various processes using a satellite signal from a GPS satellite. However, a positioning satellite of Global Navigation Satellite System (GNSS) other than GPS or a satellite signal from a positioning satellite other than GNSS may be used. For example, satellite signals from one or two or more of satellite positioning systems such as Wide Area Augmentation System (WAAS), European Geostationary-Satellite Navigation Overlay Service (EGNOS), Quasi Zenith Satellite System (QZSS), GLObal NAvigation Satellite System (GLONASS), GALILEO, and BeiDou Navigation Satellite System (BeiDou) may be used.

The foregoing embodiments and modification examples are merely examples, but the invention is not limited thereto. For example, the embodiments and the modification examples can also be appropriately combined.

The invention includes substantially the same configurations (for example, configurations in which functions, methods, and results are the same or configurations in which objectives and effects are the same) as the configurations described in the embodiments. The invention includes configurations in which unsubstantial portions of the configurations described in the embodiment are replaced. The invention includes configurations in which the same operational effects as the configurations described above or configurations in which the same objectives can be achieved. The invention includes configurations in which known technologies are added to the configuration described in the embodiments.

What is claimed is:

1. A data collection device comprising:
a receiver that acquires a plurality of exercise states determined based on a satellite signal transmitted from a positional information satellite and including a first exercise state in which a player is executing a first exercise event and a second exercise state in which the player is executing a second exercise event and acquires exercise information regarding the player including the plurality of exercise states from an electronic device worn on the player; and
a processor that generates first information including objects corresponding to the plurality of exercise states based on the exercise information acquired by the receiver.

2. The data collection device according to claim 1,
wherein the plurality of exercise states includes a third exercise state in which the player is executing a third exercise event.

3. The data collection device according to claim 2,
wherein the plurality of exercise states includes a first transition state in which the first exercise state is transitioning to the second exercise state and a second transition state in which the second exercise state is transitioning to the third exercise state.

4. The data collection device according to claim 2,
wherein the first exercise event is swimming, the second exercise event is biking, and the third exercise event is running.

5. The data collection device according to claim 1,
wherein the exercise information includes an elapsed time in a exercise state of the plurality of exercise states, and
wherein the first information includes information related to the elapsed time.

6. The data collection device according to claim 1,
wherein the exercise information includes an exercise situation including at least one of a heart rate, a pulse rate, a pace, a speed, a pitch, a stride, and an elapsed time of the player, and
wherein the processor generates second information including a graph that shows a change in the exercise situation over time.

7. The data collection device according to claim 1,
wherein the receiver acquires a plurality of pieces of exercise information from a plurality of respective electronic devices worn on a plurality of respective cvplayers, and
wherein the processor generates the first information including the plurality of objects associated with the plurality of players.

8. The data collection device according to claim 7,
wherein the receiver receives selection information which is based on a signal transmitted from a communicable display device, and
wherein the processor selects at least one object from the plurality of objects based on the received selection information.

9. A video generation device comprising:
a communication port that receives, from a data collection device, first information including objects corresponding to a plurality of exercise states including a first exercise state in which a player is executing a first exercise event and a second exercise state in which the player is executing a second exercise event; and
a processor that generates a first video including the objects based on the received first information,
wherein the communication port delivers the first video to a display device.

10. The video generation device according to claim 9,
wherein the plurality of exercise states includes a third exercise state in which the player is executing a third exercise event.

11. The video generation device according to claim 10,
wherein the plurality of exercise states include a first transition state in which the first exercise state is transitioning to the second exercise state and a second transition state in which the second exercise state is transitioning to the third exercise state.

12. The video generation device according to claim 10,
wherein the first exercise event is swimming, the second exercise event is biking, and the third exercise event is running.

13. The video generation device according to claim 9,
wherein the first information includes an elapsed time in the exercise state, and
wherein the processor generates the first video including the elapsed time based on the first information.

14. The video generation device according to claim 9,
wherein the communication port receives, from the data collection device, second information including a graph that chronologically shows a change in an exercise situation including at least one of a heart rate, a pulse rate, a pace, a speed, a pitch, a stride, and an elapsed time of the player,
wherein the processor generates a second video including the graph based on the received second information, and
wherein the communication port delivers the generated second video to the display device.

15. The video generation device according to claim 9,
wherein the first information includes the plurality of objects associated with each of a plurality of players, and
wherein the processor generates the first video including the plurality of objects based on the received first information.

16. The video generation device according to claim 15,
wherein the communication port transmits, to the data collection device, selection information which is based on a signal transmitted from the display device, the selection information instructing the data collection device to select at least one object from the plurality of objects based on the received selection information.

17. A video delivery system comprising:
an electronic device that is worn on a player, determines a plurality of exercise states including a first exercise state in which the player is executing a first exercise event and a second exercise state in which the player is executing a second exercise event based on a satellite signal received from a positional information satellite, and generates exercise information including the plurality of exercise states;
a data collection device that is connected to the electronic device via a network, receives the exercise information, generates first information including an object which is based on the plurality of exercise states, and transmits the first information; and
a video generation device that is connected to the data collection device via the network, receives the first information transmitted from the data collection device, generates a first video including the object based on the received first information, and delivers the first video.

18. A video delivery method comprising:
acquiring first information including objects corresponding to a plurality of exercise states including a first exercise state in which a player is executing a first exercise event and a second exercise state in which the player is executing a second exercise event;
generating a first video including the objects based on the first information; and
delivering the generated first video.

19. A non-transit computer-readable recording medium that stores a program causing a computer worn on a player to perform:
determining a plurality of exercise states including a first exercise state in which the player is executing a first exercise event and a second exercise state in which the player is executing a second exercise event based on a satellite signal transmitted from a positional information satellite;
generating exercise information regarding the player including the plurality of exercise states; and
generating first information including objects corresponding to the exercise states.

20. A non-transit computer-readable recording medium that records a program causing a computer to perform:
acquiring, from a data collection device, objects corresponding to a plurality of exercise states including a first exercise state in which a player is executing a first exercise event and a second exercise state in which the player is executing a second exercise event;
generating a first video including the objects based on the first information; and
delivering the first video to a display device.

21. A data collection device comprising:
a receiver that acquires positional information of a player from a positional information satellite and acquires exercise information regarding the player from an electronic device worn on the player, the exercise information including a plurality of exercise states, the plurality of exercise states including a first exercise state in which the player is executing a first exercise event and a second exercise state in which the player is executing a second exercise event; and
a processor that generates first information including objects corresponding to the plurality of exercise states based on the exercise information acquired by the receiver.
